(19) United States
(12) Patent Application Publication
(10) Pub. No.: US 2026/0145063 A1
(43) Pub. Date: May 28, 2026

(54) PARTICIPANT INTERACTIONS WITH A COMMUNITY EVENT BROADCAST IN A GAME STREAMING ENVIRONMENT

(71) Applicant: IGT, Las Vegas, NV (US)

(72) Inventors: Dwayne R. Nelson, Las Vegas, NV (US); Kevin Higgins, Reno, NV (US)

(21) Appl. No.: 18/958,822

(22) Filed: Nov. 25, 2024

(51) Int. Cl. A63F 13/35

(52) U.S. Cl. CPC A63F 13/35; A63F 2300/572

(57) ABSTRACT

Systems and methods that coordinate interactions between users of devices participating in a community game that is streamed, from zero, one or more of such devices to one or more client devices operating with a live streaming platform.

### BACKGROUND

In various embodiments, the systems and methods of the present disclosure coordinate interactions between users of devices participating in a community game that is streamed, from zero, one or more of such devices to one or more client devices operating with a live streaming platform.

Gaming machines may provide users awards in primary games. Gaming machines generally require the user to place a wager to activate the primary game. The award may be based on the user obtaining a winning symbol or symbol combination and on the amount of the wager.

### BRIEF DESCRIPTION OF THE SEVERAL VIEWS OF THE DRAWINGS

FIG. 1A is an example configuration of an architecture of a plurality of different components of the system of the present disclosure.

FIG. 1B is an example configuration of another architecture of a plurality of different components of the system of the present disclosure.

FIG. 1C is an example configuration of another architecture of a plurality of different components of the system of the present disclosure.

FIG. 2 is an example graphical user interface displayed to a viewer of a client device in association with a live stream of a gaming session occurring at a streaming device.

FIG. 3A are example graphical user interfaces displayed to a user of a device in association with a participant joining a lobby for a streamed community game.

FIG. 3B is an example graphical user interface displayed to a user of a device in association with enough participants having joined a lobby to initiate a streamed community game.

FIG. 3C are example graphical user interfaces displayed to users of devices in association with a side-wager placed between the users in association with a streamed community game.

FIG. 4A are example graphical user interfaces displayed to a user of a device in association with participants playing a streamed community game.

FIG. 4B are example graphical user interfaces displayed to a user of a device in association with participants playing a streamed community game and the elimination of audio/video content associated with one of the participants.

FIG. 5A is an example graphical user interface displayed to a user of a device in association with the scaling of audio/video content of the ranked participants playing a streamed community game.

FIG. 5B is an example graphical user interface displayed to a user of a device in association with the audio/video content of a winning participant from a play of a streamed community game.

FIG. 5C is an example graphical user interface displayed to a user of a client device in association with wagering opportunities for the user of the client device on a play of a streamed community game.

FIG. 6 is a schematic block diagram of one embodiment of an electronic configuration of an example electronic gaming machine of the present disclosure.

FIGS. 7A and 7B are perspective views of example alternative embodiments of an electronic gaming machine of the present disclosure.

FIG. 7C is a front view of an example personal gaming device of the present disclosure.

### DETAILED DESCRIPTION

In various embodiments, the systems and methods of the present disclosure coordinate interactions between users of devices participating in a community game that is streamed, from zero, one or more of such devices to one or more client devices operating with a live streaming platform.

In certain embodiments, the systems of the present disclosure enable multiple users of multiple devices the opportunity to sequentially or simultaneously partake in a multiple participant event, such as a play of a community game. In these embodiments, the system captures certain content generated in association with the multiple participant event and broadcasts such captured content to one or more users of one or more client devices viewing the multiple participant event. In certain such embodiments, in facilitating the streaming of content being delivered to one or more client devices, the system enables different devices associated with different users participating in the multiple participant event to operate as a streaming device at different points in time prior to, during and/or after the multiple participant event. In certain additional or alternative embodiments, the system enables, at different points in time prior to, during and/or after the multiple participant event, one or more participants in the multiple participant event (and/or users of client devices viewing the multiple participant event) the opportunity to interact with one or more of the participants of the multiple participant event. In certain such embodiments, the system captures such interactions and sequentially or simultaneously broadcasts such captured interactions to one or more users of one or more client devices viewing the multiple participant event. Such a configuration of employing a multiple participant event into a streaming environment overcomes certain physical constraints associated with communal gaming (e.g., the limited amount of space casinos have for electronic gaming machines that provide multiple participant events as well as the disconnect between users of these multiple participant events when the electronic gaming machines are spaced far enough apart from each other that the users are unable to interact with each other). Such a configuration of employing a multiple participant event into a streaming environment offers an avenue to incorporate, independent of user locations, captured content of certain users as well as interactions between different users which certain users prefer to participate in and/or view.

In operation of certain embodiments in which the multiple participant event includes a community game, upon an occurrence of a community game triggering event, the system triggers a community game and awaits for one or more occurrences of a community game participant selection event. Each occurrence of the community game participant selection event determines one or more users that will participate in the triggered community game (and thus determines which devices will potentially operate as a streaming device during part or all of the community game). As such, following the determination to trigger a play of a community game, the system makes one or more follow-up determinations to select the plurality of users to participate in the triggered play of the community game. In certain of these embodiments, for the users that are determined eligible to potentially participate in the community game and/or the devices capable as operating as a streaming device that are determined as eligible to stream content of the community game as a streaming device, the system monitors one or more events occurring in association with such eligible users (and/or occurring in association with the devices of such eligible users) and utilizes such events to determine whether or not the users of such devices will participate in the community game. In certain embodiments in which potential participants in the community game are playing different games at different devices and/or are associated with different attributes, the system employs different events in determining which users are selected to participate in the community game.

In certain embodiments, as the system selects one or more users of one or more devices to participate in the triggered community game, the system causes the devices of the selected users to display a lobby or staging area for the community game. Once routed to a lobby, the system enables the selected users to interact with each other (and/or with certain non-selected users of client devices) while waiting for the community game to proceed. In certain of these embodiments, such interactions include certain selected users engaging with each other (and/or with users of client devices) in anticipation of the play of the community game. In certain of these embodiments, such interactions additionally or alternatively include certain selected users placing side-wagers amongst each other (and/or with invited users to the lobby) regarding one or more events that may or may not occur in association with the community game. In certain embodiments that employ a lobby to foster pre-community game interactions amongst selected users, the system captures these interactions and incorporates part or all of such interactions in the live stream being broadcast by the live streaming platform.

In certain embodiments, upon the system determining to proceed with the play of the community game (e.g., upon the system determining that a threshold quantity of users have been selected and/or upon a certain amount of time since the occurrence of the community game triggering event), the system advances to the play of the community game. In these embodiments, following the selection of multiple users of multiple devices to participate in the community game, the system proceeds with the play of the community game displayed by one or more of the devices of one or more of the selected users. In certain such embodiments, for part or all of the play of the community game, the system enables one or more devices of one or more selected users to simultaneously or sequentially operate with a live streaming platform to stream content originating at such devices to one or more client devices also operating with the live streaming platform. By enabling one or more devices to operate as a streaming device for part of the play of the community game, the system dynamically reconfigures the individual roles of one or more devices from not providing content viewable by users at client devices to providing content viewable by users of client devices during the course of the play of the community game.

In certain embodiments, in addition to determining zero, one or more awards made available to zero, one or more of the participants of the play of the community game and similar to the lobby environment prior to the play of the community game, the system enables the participants in the community game to interact with each other (and/or with non-selected users of client devices) during the play of the community game as well as following the play of the community game. In certain embodiments, such interactions during the play of the community game include participants placing wagers on the play of the community game and/or side-wagers amongst each other regarding one or more events that may or may not occur in association with the community game. In certain additional or alternative embodiments, such interactions after the play of the community game include participants celebrating the results of the community game. In certain of these embodiments that employ community game interactions amongst selected users and/or post-community game interactions by one or more selected users, the system captures these interactions and incorporates part or all of such interactions in the live stream being broadcast by the live streaming platform.

Accordingly, in certain embodiments, the system of the present disclosure enables different devices to operate as a streaming device prior to a multiple participant event (e.g., to capture interactions between users selected to participate in the multiple participant event), during the multiple participant event (e.g., to capture community game content and/or interactions between participants of the multiple participant event) and/or after the multiple participant event (e.g., to capture participant reactions to the multiple participant event). By dynamically configuring streamed content from different devices in association with different portions of a multiple participant event, the system benefits both users of these devices (in respect to enabling such users to operate as a streamer for at least part of a multiple participant event) and users of other devices (in respect to offering such users a more diverse source of content). As such, employing multiple devices to operate, simultaneously or sequentially, as a streaming device for different parts of a multiple participant event represents an operational change that overcomes the technical challenges (e.g., in quantity of participants that may join and in remote locations of participants) presented with how multiple participant events, such as community games, are currently employed at gaming establishments.

In various embodiments, the present disclosure is directed to a system including various components and/or sub-systems that operate individually and/or collectively to enable a first user to participate in a live stream of their gaming experience and potentially reap certain benefits (in the form of awards, notoriety and interactions with other users) associated with such participation. In various such embodiments, the various components and/or sub-systems operate individually and/or collectively to capture live stream data and upload the captured live stream data. The various components and/or sub-systems additionally or alternatively operate individually and/or collectively to enable one or more second users to view and/or interact with the captured live stream and/or a modification of the captured live stream to also potentially reap certain benefits (in the form of awards, notoriety and interactions with other users).

In various embodiments, the live streaming system of the present disclosure employs, at a given point in time, a streaming device, such as a streaming electronic gaming machine or a streaming personal gaming device, that enables a first user (e.g., a streamer or influencer at a selected streaming device) to participate in one or more gaming sessions. In these embodiments, the live streaming system of the present disclosure further employs a client device, such as viewing electronic gaming machine or a viewing personal gaming device, that enables a second user (e.g., a viewer or follower at a client device) to view, interact with and/or participate in the one or more gaming sessions occurring at the selected streaming device. In such embodiments, the selected streaming device communicates data associated with the gaming sessions and/or data associated with the first user which is independent of the gaming sessions to one or more components of a live streaming platform. The one or more components of the live streaming platform utilize the communicated data to offer various features and functions to the second users at the client devices.

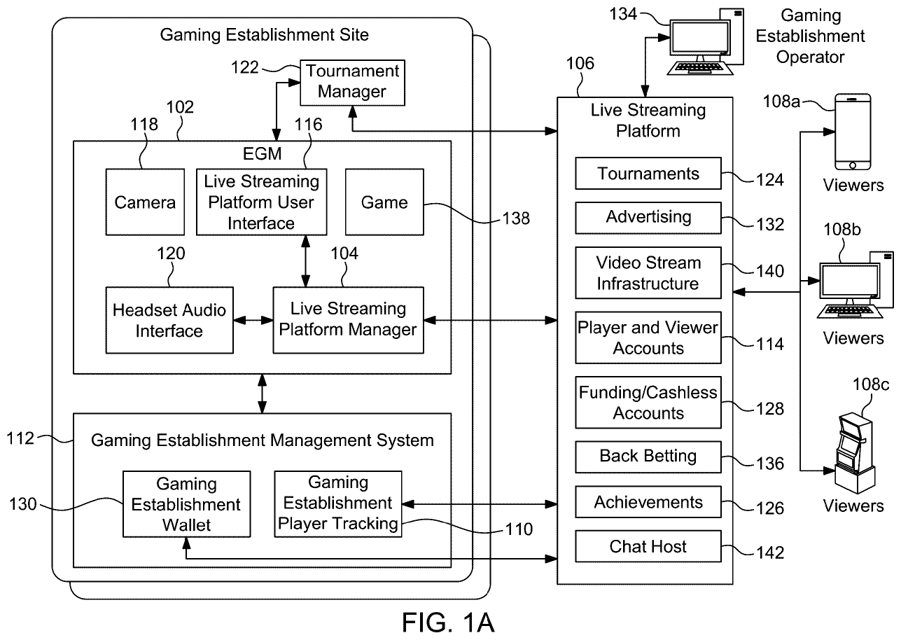

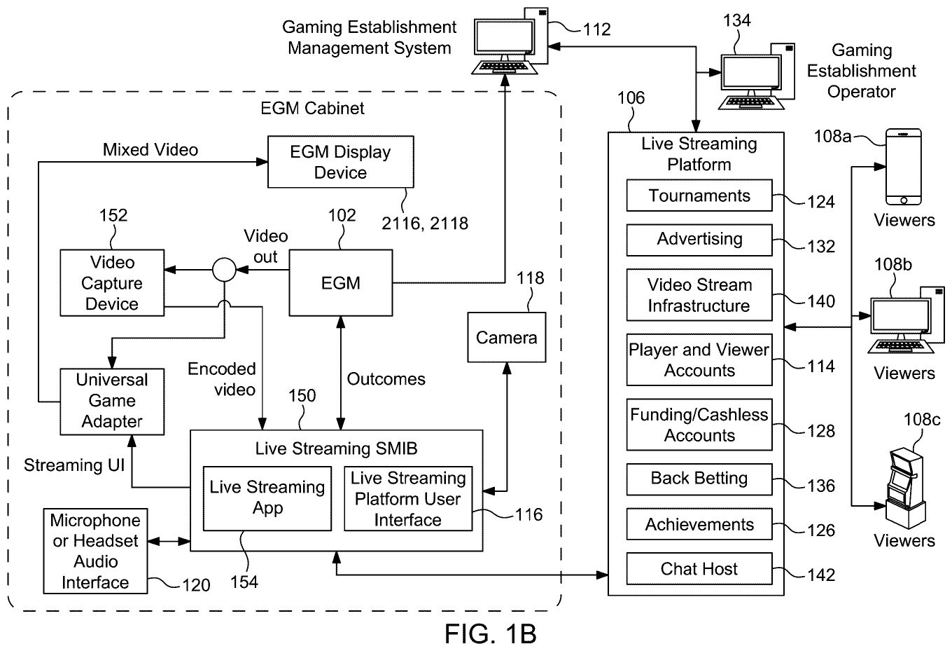

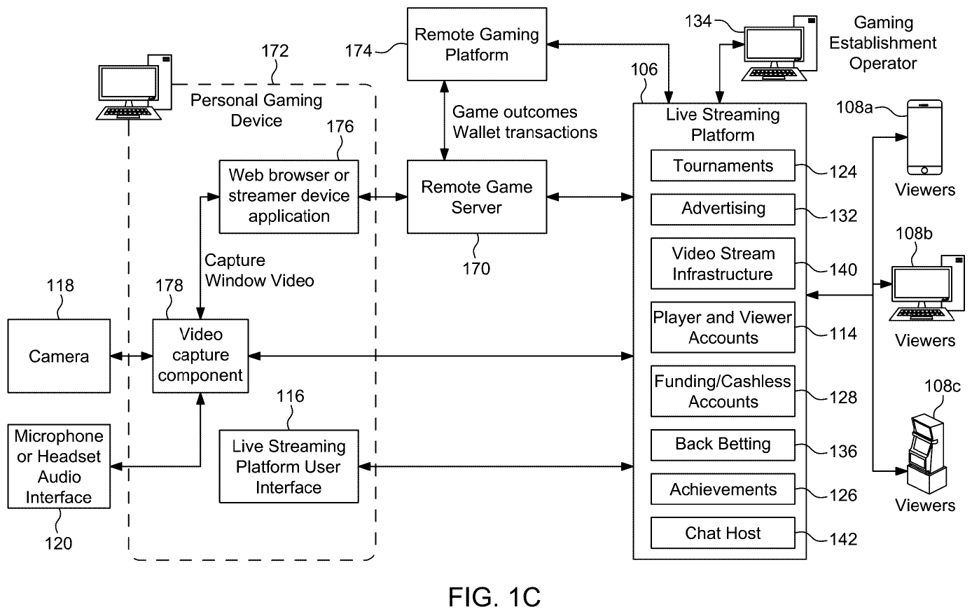

In certain embodiments, the selected streaming device and/or the client device comprises an electronic gaming machine (“EGM”) including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities). In certain such embodiments, the EGM operating as the selected streaming device interacts with the live streaming platform to facilitate the live streaming system of the present disclosure as well as foster any interactions between a user of the EGM and/or one or more viewers. In these embodiments, the EGM communicates data regarding one or more aspects of a gaming session to one or more components of the live streaming platform which operate to publish content to zero, one or more client devices. For example, as seen in FIG. 1A, the system employs an EGM 102 as a selected streaming device that includes or is otherwise associated with a live streaming platform manager 104 that interacts with the live streaming platform 106 to enable a live stream of one or more events occurring in association with the streaming EGM and/or interactions between the streaming EGM and one or more client devices 108a, 108b, 108c.

In certain embodiments, the selected streaming device and/or the client device comprises a component of a gaming establishment management system in communication with an EGM, such as a slot machine interface board (“SMIB”) in communication with an EGM. In certain additional or alternative embodiments, the selected streaming device and/or the client device comprises a component, such as a SMIB, that is in communication with an EGM and that operates independent of a gaming establishment management system. In certain such embodiments, the device operating as the selected streaming device interacts with the live streaming platform to facilitate the live streaming system of the present disclosure as well as foster any interactions between a user of the EGM and/or one or more viewers. In these embodiments, the device operating as the selected streaming device receives data from the EGM regarding one or more aspects of a gaming session of the EGM, and communicates part or all of such data to one or more components of the live streaming platform which operate to publish content to zero, one or more client devices. For example, as seen in FIG. 1B, the system employs a streaming SMIB 150 which operates with an EGM 102 to capture data associated with the EGM and interact with the live streaming platform 106 to enable a live stream of one or more events occurring in association with the EGM and/or interactions between the streaming SMIB (and/or associated EGM) and one or more client devices 108a, 108b, 108c.

In certain embodiments, the selected streaming device and/or the client device comprises a personal gaming device. In certain such embodiments in which the personal gaming device operates as the selected streaming device, the personal gaming device operates with a remote game server to offer one or more plays of one or more games independent of any EGM and any SMIB associated with the EGM. In certain such embodiments, the personal gaming device and/or remote game server interacts with the live streaming platform to facilitate the live streaming system of the present disclosure as well as foster any interactions between a user of the personal gaming device and/or one or more viewers. In these embodiments, the personal gaming device and/or remote game server communicate data regarding one or more aspects of a gaming session to one or more components of the live streaming platform which operate to publish content to zero, one or more client devices. For example, as seen in FIG. 1C, the system employs a remote game server 170 that operates with a personal gaming device 172, such as a mobile device or a personal computer, and a remote gaming platform 174 (which interacts with the live streaming platform 106) to enable, via an internet browser or application 176 of the personal gaming device, a live stream of one or more events occurring in association with the personal gaming device 172, one or more events occurring in association with the remote game server 170 and/or one or more interactions between the personal gaming device 172 and one or more client devices 108a, 108b, 108c.

In certain embodiments, upon an occurrence of a user identification event, the system enables a user at a selected streaming device to log into a live streaming platform account associated with the user. In different embodiments, the user logs into a live streaming platform account via one or more of: the user inserting a live streaming platform identification card (that has an encoded user identification number that uniquely identifies the user) into a card reader of the selected streaming device; the user inserting a player tracking card that functions as a live streaming platform identification card (that has an encoded user identification number that uniquely identifies the user) into a card reader of a selected streaming device; an establishment of a wireless communication link between the selected streaming device and a mobile device executing an application associated with an identified user; the utilization of any suitable biometric technology or ticket technology to identify a user associated with a gaming session occurring at a selected streaming device. In certain embodiments, with reference to FIG. 1A, wherein the system includes or is otherwise in communication with a gaming establishment player tracking system 110 of a gaming establishment management system 112, the user identification occurs in association with a user logging into the player tracking system from an EGM 102. In this embodiment, the EGM communicates the user identification data to one or more components of the live streaming platform 106 (e.g., a server of the live streaming platform) which log the user into a live streaming account 114 associated with the user and maintained in association with the live streaming platform. In certain embodiments in which the system is separate from and not in communication with a gaming establishment player tracking system, the user identification occurs in association with a user logging into the live streaming platform from the selected streaming device (such as by the user entering an identification and password or login code at the selected streaming device). In this embodiment, the selected streaming device communicates the user identification data to one or more components of the live streaming platform which log the user into the live streaming account associated with the user.

In certain embodiments, in association with a user logging into a live streaming platform account of the live streaming platform from a selected streaming device, the system enables the user to enable/disable certain components of the selected streaming device. In certain embodiments, in association with a user logging into a live streaming platform account of the live streaming platform from a selected streaming device, the system enables the user to modify the settings or parameters of certain components of the selected streaming device. In these embodiments, as seen in FIGS. 1A to 1C, as part of configuring the selected streaming device to operate with the live streaming platform, the system utilizes a live streaming platform user interface 116 to enable a user to modify zero, one or more aspects of the selected streaming device as they relate to how the selected streaming device operates with the live streaming platform.

In one such embodiment, the system enables the user to modify the use of one or more display devices of the selected streaming device and/or one or more display devices separate from, but associated with, the selected streaming device. For example, the system enables the user to enable or disable one or more display devices of the selected streaming device from displaying the images captured by the selected streaming device which are displayed to the viewers. In another example, the system additionally or alternatively enables the user to modify the settings of the display device(s) of the selected streaming device, such as modifying the screen layout of the selected streaming device by selecting an area of the display device to display the live stream displayed to the viewers, or modifying whether to utilize a split screen to display the live stream displayed to the remote users.

In another such embodiment, the system enables the user to modify the use of one or more cameras of the selected streaming device and/or one or more cameras separate from, but associated with, the selected streaming device. For example, as seen in FIGS. 1A to 1C, since one or more cameras 118 of the selected streaming device may be used to capture data of the user playing the selected streaming device, the system enables the user to enable or disable the camera(s) of the selected streaming device from capturing one or more images of the user playing the selected streaming device. In another example, the system additionally or alternatively enables the user to modify the settings of the camera(s) of the selected streaming device, such as modifying the resolution of the camera, modifying the color settings of the camera (e.g., to capture images in color or black and white), modifying the use of a green screen.

In another such embodiment, the system enables the user to modify the use of one or more sound generating devices, such as speakers, of the selected streaming device and/or one or more sound generating devices separate from, but associated with, the selected streaming device. For example, since one or more speakers of the selected streaming device may be used to generate sounds communicated from one or more viewers at one or more client devices, such as comments made by one or more viewers, the system enables the user to enable or disable the speaker(s) of the selected streaming device. In another example, the system additionally or alternatively enables the user to modify the settings of the speaker(s) of the selected streaming device, such as modifying the volume of the speakers.

In another such embodiment, the system enables the user to modify the use of one or more sound capture devices, such as microphones, of the selected streaming device and/or one or more sound capture devices separate from, but associated with, the selected streaming device. For example, since one or more microphones of the selected streaming device may be used to capture the sounds at the selected streaming device, such as comments made by the user, the system enables the user to enable or disable the microphone(s) of the selected streaming device. In another example, the system additionally or alternatively enables the user to modify the settings of the microphone(s) of the selected streaming device, such as modifying the sensitivity of the microphone(s).

In another embodiment, in addition to or alternatively from modifying the settings of one or more components of the selected streaming device and/or components separate from, but associated with, the selected streaming device, the system enables a user to connect or otherwise pair a peripheral device with the selected streaming device and utilize the connected peripheral device in association with the capturing of data for the live stream. That is, the system of this embodiment enables the user to connect one or more peripherals to the selected streaming device to further enhance the broadcasting experience.

In one embodiment, the peripheral device includes a mobile device (with or without a camera) wherein the system enables a user to wirelessly connect or otherwise pair the mobile device to the selected streaming device such that the user can interact with their audience of viewers using the mobile device. In one such embodiment, the wireless communication link includes a direct pairing such that when the user of the mobile device is currently located at or otherwise engaging with a selected streaming device, a direct pairing or linkage occurs between the mobile device and the selected streaming device utilizing one or more wireless communication protocols, such as Bluetooth™ signals, Bluetooth™ Low Energy (“BLE”) signals, one or more cellular communication standard (e.g., 3G, 4G, 5G, 6G, LTE) signals, one or more Wi-Fi compatible standard signals and/or one or more short range communication signals, such as near field communication (“NFC”) signals protocol). In another such embodiment, the wireless communication link includes an indirect pairing such that when the user of the mobile device is currently located at or otherwise engaging with a selected streaming device and wirelessly connected to one or more servers, such as servers of a gaming establishment, an indirect pairing or linkage occurs between the mobile device and the selected streaming device via the one or more servers. In another embodiment, in addition to or alternative from using the mobile device as a peripheral device associated with the selected streaming device, the system enables the user to utilize a paired mobile device (which is running a mobile device application configured to interface with the selected streaming device) to display a live streaming platform user interface such that the user can adjust one or more settings on the selected streaming device which pertain to the live stream.

In another embodiment, the peripheral device includes a headset (including a microphone) wherein the system enables a user to connect or otherwise pair the headset (e.g., headset audio interface 120 of FIGS. 1A to 1C) to the selected streaming device such that the user can speak with their audience of viewers at client devices. In this example, if the headset is a wired headset, the system enables the user to connect to the selected streaming device over USB Audio, standard analog headphone and speaker jacks, or optical inputs and outputs. On the other hand, if the headset is a wireless headset, the system enables the user to connect to the selected streaming device via establishing a wireless communication link with the headset. In these embodiments, if the peripheral device requires a power source, the system further enables the user to power such connected peripheral devices via one or more USB power outlets and/or wireless charging devices.

In certain embodiments, in addition to enabling a user to connect a peripheral device to the selected streaming device, the system adjusts one or more settings of the selected streaming device responsive to the detection of a connected peripheral device. For example, upon the selected streaming device detecting that headphones are connected, the system mutes one or more speakers of the selected streaming device and routes one or more sound outputs to the headphones so that the risk of echo when the user is speaking into their headphone microphone is minimized. In one such example, the system routes all sound outputs to the headphones. In another such example, the system routes certain sound outputs to the headphones but continues routing other sound outputs, such as sounds associated with large jackpots, sounds occurring during certain in-game bonuses, or other sounds that contribute to the general ambiance of the gaming establishment for exciting events, to the speakers of the selected streaming device.

It should be appreciated that while certain adjustments to one or more components of the selected streaming device occur in association with a user logging into a live streaming platform account of the live streaming platform, in certain additional embodiments, one or more adjustments to one or more components of the selected streaming device occur based on the live stream of the user's gaming session. In these embodiments, the selected streaming device displays (either continuously or responsive to one or more inputs made by the user during the user's gaming session) one or more live streaming platform user interfaces which enable the user to change one or more configurations of the selected streaming device that pertain to the broadcasted live stream of the user's gaming session. For example, since one or more display devices of the selected streaming device and/or speakers of the selected streaming device may be utilized to provide the user the live stream which is broadcasted to one or more viewers at client devices, the system gives the user of the selected streaming device instant feedback and enables the user to modify one or more settings of any suitable component utilized to produce the live stream, such as a camera of the selected streaming device, a camera paired with the selected streaming device, a microphone of the selected streaming device or a microphone paired with the selected streaming device.

In another embodiment, in addition to or alternatively from adjusting one or more settings of the selected streaming device based on the feedback of the user, the system displays to the user certain information regarding the user's live stream to provide the user at the selected streaming device a more immersive experience to foster more interaction with the viewers at the client devices. For example, the selected streaming device utilizes a user feedback display to display to the user statistics about how many viewers are viewing the user's play online at the current point in time. In another example, the selected streaming device utilizes a user feedback display to inform the user at the selected streaming device of a current live chat associated with the user's gaming session so that the user can respond (using a microphone to provide comments and/or answer requests from viewers). In another example, the selected streaming device utilizes a user feedback display to display non-game play statistics for the play session, such as total gifts given, gifts given to charity, or any award given to the user by viewers. In different embodiments, the system displays none, part or all of the information of this user feedback display to the viewers of the live stream.

In certain embodiments, following the occurrence of the user identification event and any modifications to any components of (or associated with) the selected streaming device, one or more components of the system of the present disclosure monitor for an occurrence of a capture event that potentially results in the generation of content to be streamed to one or more viewers at one or more client devices. In these embodiments, responsive to an occurrence of a capture event, the system captures live stream data associated with the gaming session occurring at the selected streaming device. In certain embodiments, the live stream data comprises audio/visual content generated by the selected streaming device and/or captured by the selected streaming device. In certain embodiments, the live stream data additionally or alternatively comprises selected streaming device data associated with the gaming session and/or the selected streaming device, such as, but not limited to, meter data (e.g., money in, money out, money wagered, money won), configuration data (e.g., manufacturer, denomination, paytable data), bonusing data (e.g., progressive win, system bonus win), ticket in/ticket out data, and/or cashless fund transfer data.

In certain embodiments, the system captures the content generated by the selected streaming device, such as content displayed by one or more display devices of the selected streaming device, to broadcast to the viewers (with the possible addition of supplemental content). In another such embodiment, the system captures certain content generated by the selected streaming device, such as content displayed by areas or windows of one or more display devices of the selected streaming device, to broadcast to the viewers (with the possible addition of supplemental content). In this embodiment, rather than displaying to the viewers all the content which the user at the selected streaming device sees (which may include external controlled interface content personal to the user or other sensitive content not intended to be broadcasted), the system captures certain content, such as a game play content, and does not capture certain other content.

In certain embodiments, following the capture of live stream data, the system determines whether a captured data modification event has occurred. That is, after obtaining the data associated with the content generated by the selected streaming device which forms at least part of the live stream and prior to enabling any viewers access to that particular captured data of the live stream, the system determines whether one or more events have occurred to augment such content by changing part of the content, removing part of the content and/or adding to the content.

If the system determines that a captured data modification event occurred, the system modifies the live stream data captured from the selected streaming device. In other words, upon an occurrence of a modification event and prior to enabling any viewers access to that particular captured data of the live stream, the system modifies or otherwise alters the data captured from the selected streaming device to supplement the live stream with additional information. In various embodiments, supplemental content derived from this additional information is added to the live stream by overlaying the supplemental content onto a captured frame of a display device of the selected streaming device and/or separately displaying the supplemental content along with a captured frame of a display device of the selected streaming device such that the live stream includes audio-visual content of the user's gaming session as well as the additional information.

In certain embodiments, the additional information utilized to form the supplemental content added to the live stream includes one or more of: still images (e.g., a photograph of a user's reaction during a play of a game), video clips (e.g., a video of a user's reaction to a play of a game), sound clips (e.g., a user's verbal reaction to a play of a game), augmented still images (e.g., an augmented photograph of a user's reaction during a play of the game, such as the user's reaction modified via one or more filters or superimposed with an outcome of a play of the game), augmented video clips (e.g., an augmented video recording of a user's reaction to a play of a game), augmented sound clips (e.g., a user's augmented verbal reaction to a play of a game), audio-video clips, text, non-wagering transaction information associated with the user (e.g., an amount spent purchasing goods at a gaming establishment's luxury clothing store), location information, application usage information, event attendance information, and/or biometric information. In certain embodiments, the system informs the user of the publication of this additional information. In certain of such embodiments, the system enables the user to opt-out of (or alternatively opt-into) this feature as well as enables the user to configure notifications of when such additional information is to be published.

In another embodiment, the additional information utilized to form the supplemental content added to the live stream includes details about the user's current (or historical) gaming session, such as, but not limited to, a largest award amount won in the gaming session, a duration of the gaming session, an average amount wagered for the gaming session, a total amount wagered for the gaming session, a total amount won for the gaming session, an average amount won for the gaming session, and/or any jackpots won for the gaming session.

In another embodiment, the additional information utilized to form the supplemental content added to the live stream includes details about one or more tournaments the user is currently participating in (or historically participated in). In this embodiment, multiple users participate in a gaming establishment tournament where users compete to determine who will win the tournament and one or more users in the tournament stream their play live using the live streaming platform of the present disclosure. For example, the system offers a tournament to eligible viewers (e.g., viewers that pay a fee or have a relationship with the user of a selected streaming device) in which wagers are placed by client devices over a period of time and the client device with the largest win at the end of the period is the winner of the tournament. In such a configuration, the live streaming platform is linked to the system running the tournament and tracking the score of the selected streaming devices that are participating. The live streaming platform uses the data published by the tournament system, such as a tournament manager server (e.g., a component of a tournament management system 122 in communication with the selected streaming device of FIG. 1A), to display additional information regarding any streamed tournaments (e.g., tournaments 124 offered in association with the live streaming platform of FIGS. 1A to 1C). Such additional information includes, but is not limited to, a current leaderboard of the tournament, a current standing in the tournament (i.e., the user's current position on the leaderboard of the tournament), a largest award amount won in the tournament, a duration of the tournament, an average amount wagered in the tournament, a total amount wagered in the tournament, a total amount won in the tournament, an average amount won in the tournament, and/or any jackpots won in the tournament.

In another embodiment, the additional information utilized to form the supplemental content added to the live stream includes details about any achievements earned or otherwise associated with the user and/or the user's current (or historical) gaming session. In this embodiment, the system utilizes game outcome data published by the selected streaming device to the live streaming platform to associate the user of the selected streaming device (and/or the user of the client device) with one or more achievements such as badges, avatars, access to one or more emojis, awards (in the form of monetary credits, non-monetary credits, physical goods, and/or any award of the present disclosure). The system causes information about such achievements (e.g., achievements 126 maintained in association with the live streaming platform of FIGS. 1A to 1C) to be overlaid onto or displayed along with the captured frames. In different embodiments, such achievements are earned or otherwise associated with the user based on the historical play statistics of the user and/or the historical play statistics of the user relative to the historical play statistics of one or more other users (to determine how each user has relatively performed during one or more gaming sessions). It should be appreciated that while such achievements may be based on game outcome data of a wager amount and any awards, game outcome data may additionally be based on any trackable event occurring in association with a play of a game (e.g., for a play of poker game, the game outcome data includes the hand of playing cards initially dealt, the playing cards held by the user, the final hand of playing cards and any associated award), or occurring independent of any play of any game but otherwise associated with the user's gaming session.

In another embodiment, the additional information utilized to form the supplemental content added to the live stream includes details about a quantity of viewers currently viewing the user's gaming session. In another such embodiment, the additional information includes historical details about a quantity of historical viewers whom have viewed the user's historic gaming sessions. In another embodiment, the additional information utilized to form the supplemental content added to the live stream includes details about a quantity of views of the user's gaming session. In another such embodiment, the additional information includes historical details about a quantity of historical views of the user's historic gaming sessions. In another embodiment, the additional information utilized to form the supplemental content added to the live stream includes details about a quantity of viewers following the user (i.e., a number of followers of the user). In another embodiment, the additional information utilized to form the supplemental content added to the live stream includes details about a quantity of subscribers associated with the user.

In another embodiment, the additional information utilized to form the supplemental content added to the live stream includes details about any gifts or awards sent to the user of the selected streaming device by one or more viewers of one or more client devices. In this embodiment, viewers can send monetary gifts to users as a virtual “thank you” for playing well, or performing some action requested by a viewer, wherein the system displays such gifts (either individually or collectively) such that the viewers see the live stream of the user's gaming session as well as information regarding such gifts. For example, a viewer congratulates the user for earning a royal flush in a poker game by gifting them $5. In another example, a viewer requests, through an online chat, that the user hold certain cards in a poker hand by gifting the user some amount of money. In another embodiment, one or more gifts given to users participating in the tournament by viewers impact a user's position in an ongoing tournament. For example, if a user has a credit meter balance of $500 after two minutes of play, and they're currently ranked 3^{rd} on the leaderboard, and an online viewer gifts that user $200, then the user may jump into 2^{nd} place on the leaderboard. It should be appreciated that these gifts are funded by electronic credits that viewers establish with the live streaming platform. That is, as seen in FIG. 1A to 1C, the system of the present disclosure utilizes accounts associated with viewers 128 that are maintained by one or more components of the live streaming platform and/or one or more components independent of but associated with the live streaming platform. The system employs such accounts to transfer funds to one or more digital accounts or electronic wallets (e.g., gaming establishment account 130 of FIG. 1A) and/or to one or more components of a gaming establishment fund management system that maintain one or more gaming establishment accounts, such as cashless wagering accounts, associated with such users. In different embodiments, such funds are transferred from an account associated with the viewer to an account associated with the user, from an account associated with the viewer to a cashless wagering account maintained for the user by a cashless wagering system of a gaming establishment, and/or from an account associated with the viewer to a credit balance of the selected streaming device (wherein such transfers are recorded using existing wagering account transfer or bonus meters tracked by a selected streaming device, or view additional meters added to track such transfers). In another embodiment, such funds are transferred from an account associated with a viewer to the selected streaming device wherein rather than such funds directly modifying a credit balance of the selected streaming device, such funds contribute to one or more game outcomes determined by the selected streaming device (e.g., a gift of $5 from a viewer is provided to the user at the selected streaming device as an award of $5 associated with a game outcome determined in association with a play of a game). It should be appreciated that any suitable digital wallet or account which maintains or is otherwise associated with an amount of funds for a user at a selected streaming device and/or a viewer may be utilized in association with the present disclosure.

In another embodiment, the additional information utilized to form the supplemental content added to the live stream includes details about any gifts provided to any charities associated with the user of the selected streaming device by one or more viewers at one or more client devices. In this embodiment, viewers can send monetary gifts to a charity of the user's choosing as a virtual “thank you” for playing well, or performing some action requested by a viewer, wherein the system displays such charitable gifts (either individually or collectively) such that the viewers see the live stream of the user's gaming session as well as information regarding such gifts. For example, a viewer congratulates the user for playing for a certain amount of time by providing a gift of $50 to a charity designated by the user. It should be appreciated that the charitable gift given by a viewer is funded by transferring money from an account that viewer established with the live streaming platform to one or more financial institution accounts associated with the charity and maintained by one or more financial institutions.

In another embodiment, the additional information utilized to form the supplemental content added to the live stream includes advertising data associated with a gaming establishment wherein the selected streaming device is located and/or a third party. For example, as seen in FIGS. 1A to 1C, the selected streaming device broadcasting the user's video stream operates with the live streaming platform 106 to encode an advertisement 132 for a gaming establishment in the video. For example, the gaming establishment advertisement includes an embedded audio/video clip, such as footage of the user at the selected streaming device or a promotional audio/video clip of a show attended by the user at a gaming establishment, along with attendance information regarding a user attending the show, the gaming establishment where the concert occurred and advertising text describing upcoming dates for the show. In these embodiments, the gaming establishment advertisement (and/or third party advertisement associated with the live stream) offers the viewers different benefits, such as awards, discounts, free points, free promotional credits at the gaming establishment for signing up for a visit to the gaming establishment, for viewing the live stream or associating the viewer's player tracking account with their viewer account. In different embodiments, different levels of activity by the viewers are associated with different benefits, wherein the benefit provided to the viewer is based on how much they watch, how many gifts they give users, or how many bets they place. In these embodiments, such benefits are funded by a gaming establishment if the gaming establishment that is hosting the user gets a percentage of the subscriptions to a user's channel, gifts, and/or bets (or a percentage of the hold associated with such bets).

In another embodiment, the additional information utilized to form the supplemental content added to the live stream includes details about an additional wager placed by the user at the selected streaming device. In one such embodiment, the selected streaming device enables users to place wagers on sporting events while at the selected streaming device, wherein the information regarding such sports wagers is broadcast as part of their live stream. In this embodiment, as the events associated with a sports wager made occur or finalize, the results of the sports wager are reported to the live streaming platform by the selected streaming device (or the sports betting system which maintains and tracks such wagers). Such reporting enables the live streaming platform to update the appropriate user statistics and possibly award the user any achievements as described above.

In certain embodiments, in addition to or alternatively from modifying the live stream data captured from the selected streaming device with additional information, the modification of the live stream data includes removing certain of the captured live stream data or otherwise altering the captured live stream data. In these embodiments, rather than displaying to the viewers all the content which the user at the selected streaming device sees (which may include external controlled interface content personal to the user or other sensitive content not intended to be broadcasted), the system obscures certain content prior to being broadcasted to any viewers. For example, if a selected streaming device is currently displaying a live video stream associated with a sporting event in a window of a display device of the selected streaming device and the live streaming platform lacks the content licenses to also display the live video stream of the sporting event, the system blacks out, grays out or otherwise masks the live video stream of the sporting event from being displayed to viewers.

Following the modification of the data captured from the selected streaming device or if the system determines that a captured data modification event did not occur, the system uploads the live stream data to the live streaming platform. In certain embodiments, the uploaded live stream data comprises unmodified captured live stream data (e.g., unmodified audio/visual content generated by the selected streaming device and/or content captured by the selected streaming device). In certain additional or alternative embodiments, the uploaded live stream data comprises modified captured live stream data (e.g., modified audio/visual content generated by the selected streaming device and/or modified content captured by the selected streaming device). In certain additional or alternative embodiments, the uploaded live stream data comprises selected streaming device data associated with the gaming session and/or the selected streaming device. In one example in which the selected streaming device is an EGM, as seen in FIG. 1A, the live streaming platform manager 104 associated with the EGM uploads certain of the live stream data to a video stream infrastructure component 140 of the live streaming platform 106.

In another example in which the selected streaming device is a SMIB associated with an EGM, as seen in FIG. 1B, a live streaming application 154 being executed by the SMIB uploads certain of the live stream data to the video stream infrastructure component 140 of the live streaming platform 106. In certain embodiments in which the selected streaming device comprises a component of a gaming establishment management system, such as a SMIB associated with an EGM, to enable the streaming SMIB to capture live stream data from the EGM and communicate the live stream data to one or more components of the live streaming platform, the streaming SMIB comprises various hardware and/or software interfaces. In certain embodiments, the streaming SMIB includes zero, one or more video inputs with hardware interfaces (e.g., HDMI, DVI, VGA or Ethernet), zero, one or more audio inputs (e.g., 3.5 mm analog input or a fiber optic input) and zero, one or more communication interfaces (e.g., serial, Ethernet, fiber or wireless) with the EGM. In certain embodiments, the streaming SMIB includes zero, one or more connections to one or more servers of the live streaming platform and/or one or more servers of the gaming establishment management system. In these embodiments, as seen in FIG. 1B, the streaming SMIB operates with a video capture device 152 to encode video data outputted by the EGM into one or more video formats for streaming and communicate that video data to one or more video stream infrastructure components 140 of the live streaming platform 106.

In another example in which the selected streaming device is a personal gaming device operating with a remote game server, as seen in FIG. 1C, a video capture component 178 of the personal gaming device 172 uploads certain of the live stream data to the video stream infrastructure component 140 of the live streaming platform 106. In certain embodiments in which the selected streaming device comprises a personal gaming device 172 operating with a remote game server 170 and a remote gaming platform 174 that maintains one or more user accounts and operates with the remote game server to enable wagering of plays of games with funds held in such maintained user accounts, to enable the capturing of live stream data and communication of the live stream data to one or more components of the live streaming platform, a video capture component 178 associated with the personal gaming device interfaces with zero, one or more peripheral devices (e.g., camera 118 and headset audio interface 120) to capture certain data of the live stream. In these embodiments, the streaming personal gaming device (operating with the video capture component and employing certain data communicated from the remote game server and/or the remote gaming platform) encode video data outputted by the personal gaming device into one or more video formats for streaming and communicate that video data to one or more video stream infrastructure components 140 of the live streaming platform 106.

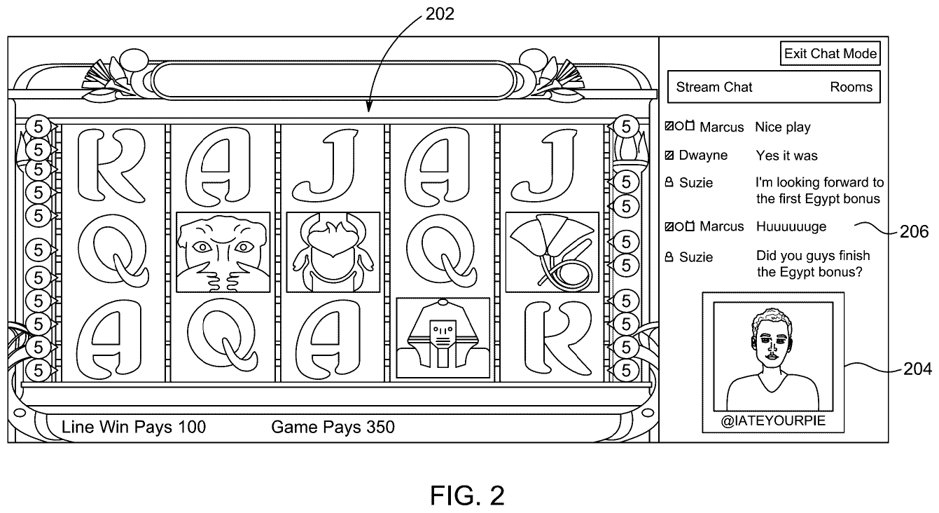

Following the upload of live streaming data, the live streaming platform enables one or more viewers at one or more client devices to access the live stream data. In certain embodiments, the live streaming platform enables viewers at the client devices to view the live stream and, in certain instances, interact with the selected streaming device. For example, as seen in FIGS. 1A to 1C, the live streaming platform 106 enables viewers at different client devices (e.g., a mobile client device 108a, a personal client device 108b and an EGM operating as a client device 108c) to view the live stream (including, but not limited to, as seen in FIG. 2, viewing a play of a game 202 and audio/video content of the user at the selected streaming device 204) and, in certain instances, interacting with the selected streaming device (including, but not limited to, as also seen in FIG. 2, chatting with the user at the selected streaming device 206 in one or more chat windows or chat rooms).

In certain embodiments, the live streaming platform enables any viewer to access any live stream associated with any selected streaming device. In certain embodiments, the live streaming platform restricts certain viewers from accessing certain live streams associated with certain selected streaming devices. In certain embodiments, the system restricts access to certain live streams based on one or more of an age of the viewer, a ranking of the viewer (e.g., a player tracking status of the viewer), a location of the viewer, any invitation to participate extended to the viewer, an age of the user, a location of the user, a ranking of the user (e.g., a player tracking status of the user), any invitation to participate extended to the user, any regulations pertaining to the age and/or location of the viewer, and/or any regulations pertaining to the age and/or location of the user.

In certain embodiments which impose one or more restrictions on viewers, the system enables a viewer to pay a fee (e.g., a daily fee, weekly fee, monthly fee or yearly fee) to view one or more live streams and/or participate in one or more live chats. In one such embodiment, if the system requires a viewer to pay to fully participate in the live stream, then in addition to any percentage of the fees allocated to the operator of the live streaming platform (e.g., the component associated with the gaming establishment operator 134 of FIGS. 1A to 1C), the system allocates a percentage of the fee to the user at the selected streaming device associated with the live stream. In another such embodiment, if the system requires a viewer to pay to fully participate in the live stream, then in addition to any percentage of the fees allocated to the operator of the live streaming platform, the system additionally or alternatively allocates a percentage of the fee to the gaming establishment where the selected streaming device associated with the live stream is at. In this embodiment, if the live streams associated with a user occurred via the user playing multiple selected streaming devices at multiple gaming establishments, the system splits the fees amongst the multiple gaming establishments based on any suitable fee splitting arrangement, such as based on hours played at each selected streaming device and/or coin-in at each selected streaming device.

In certain embodiments, the live streaming platform enables one or more viewers interfacing with a client device to access the live stream without further interactions. In these embodiments, the live streaming platform enables the viewer to passively observe the events occurring at the selected streaming device. In certain embodiments, the live streaming platform enables one or more viewers interfacing with a client device to access the live stream and further interact with the user at the selected streaming device. In these embodiments, the additional information utilized to form the supplemental content includes the interactions between the different users of the different devices in the live streaming environment. For example, live streaming platform interface 116 enables one or more chats (i.e., interactions) to occur between the selected streaming device and zero, one or more client devices utilizing a chat component 142 of the live streaming platform 106 of FIGS. 1A to 1C. In these embodiments, upon an occurrence of a viewer interaction event, the live streaming platform enables the viewer to not only observe the events occurring at the selected streaming device but additionally interact with the user at the selected streaming device, such as by providing gifts to the user at the selected streaming device and/or participating in a conversation with the user at the selected streaming device. In certain embodiments, the live streaming platform enables one or more viewers interfacing with a client device to access the live stream and further interact with the live streaming platform to access certain wagering features. In these embodiments, upon an occurrence of a viewer interaction event, the live streaming platform enables the viewer to not only observe the events occurring at the selected streaming device from the client device but additionally interact with the live streaming platform from the client device to place one or more wagers on one or more events occurring at the selected streaming device which are part of the live stream.

In one embodiment wherein the viewer interfacing with a client device actively interacts with the live stream, following the viewer establishing and adequately funding a live streaming wagering account (e.g., account 128 maintained in association with the live streaming platform of FIGS. 1A to 1C) and accessing a live stream associated with a gaming session at a selected streaming device, the live streaming platform enables the viewer to place a back bet (e.g., back betting opportunities 136 offered in association with the live streaming platform of FIGS. 1A to 1C). Such back bets are based on the bet placed by the user at the selected streaming device and may be associated with a play of a game (e.g., the game 138 offered by the EGM operating as the selected streaming device of FIG. 1A) occurring at the selected streaming device and/or any wagerable event occurring at the selected streaming device that is independent of any play of any game. In this embodiment, if the user at the selected streaming device does not win any award based on the placed wager, then the viewer also loses the back bet. On the other hand, if the user at the selected streaming device wins an award (having a value greater than zero) based on the placed wager, then any viewer who was back betting along with the user at the selected streaming device will win the same amount. In one such embodiment, the system provides the entire win amount of the viewer to the viewer (to place another back bet or transfer to the live streaming wagering account). In another such embodiment, the system provides or otherwise automatically gifts a portion of the win amount of the viewer to the user at the selected streaming device.

In certain such embodiments in which the live streaming platform enables the viewer to place a back bet, such as a wager on a play of a wagering game occurring at an EGM operating as the selected streaming device, in association with the play of the wagering game, the EGM streaming device notifies an associated SMIB of the EGM, using SAS or another gaming protocol, when a game starts, when a wager is placed (COIN IN), when an amount is won (COIN OUT) and when a game ends. Using these events and based on certain interactions between the user, the EGM, the SMIB operating with the EGM, the live streaming platform, the client device and an account associated with the user of the client device to fund back bets placed by the client device, the EGM to SMIB “Game Start” message includes data associated with the wager amount placed at the EGM operating as the selected streaming device (and could be implemented with the SAS protocol message, such as 0x7E) and the EGM to SMIB “Game End” message includes data associated with the win amount resulting from the wager placed (and could be implemented by the SAS protocol message, such as 0x7F). Using at least these interactions (and assuming that the amount of the back bet is the same as the wager placed at the selected streaming device and that the live streaming platform credits the account of the user of the client device with the matching amount of the win occurring at the selected streaming device), the live streaming platform can proceed with withdrawing funds from an account associated with the user of the client device to pay for the back bet placed and depositing fund to the account associated with the user of the client device based on awards won from such back bets placed (without requiring any specific information regarding the paytable of the selected streaming device and/or any paytable of the client device). That is, if the user at the selected streaming device does not win any award based on the placed wager at the selected streaming device, then the live streaming platform determines that the viewer at the client device also loses the back bet. Conversely, if the user at the selected streaming device wins an award (having a value greater than zero) based on the placed wager at the selected streaming device, then the live streaming platform determines that the viewer at the client device who placed a back bet (of the same amount as the wager placed at the selected streaming device) will win an award of the same amount. For example, if the user of the selected streaming device wagered $5.00 and won $10.00, then if the user of the client device wagered $5.00, the live streaming platform determines, independent of any paytable information, that the user of the client device also wins $10.00. Likewise, if the user of the selected streaming device wagered $5.00 and lost (i.e., won $0.00), then the live streaming platform determines, independent of any paytable information, that the user of the client device also loses their $5.00 wagered. It should be appreciated that such a configuration further enables scaling of the wager amount and the win amount without requiring any specific information regarding the paytable of the selected streaming device. For example, if the user of the selected streaming device wagered $1.00 and won $5.00 and if the user of the client device wagered $0.50 (i.e., half of the $1.00 wagered at the selected streaming device), then the live streaming platform determines that the user of the client device wins $2.50 (half of the $5.00 won at the selected streaming device).

In certain embodiments in which the live streaming platform enables the viewer to place a back bet, such as a wager on a play of a wagering game occurring at an EGM operating as the selected streaming device, the system enables session based wagering in which a client device commits to placing a series of wagers in association with a series of streamed games to be played at the selected streaming device. In these embodiments, the user of the selected streaming device creates a session including a predefined quantity of games to be played at the selected streaming device and/or including an intention of an amount of time spent playing games at the selected streaming device. A session may be available to each of the client devices, a grouping of eligible client devices or an individual client device. Following the creation of the session, the user of a client device commits, subject to having an amount of funds in one or more accounts associated with the user of the client device, to placing wagers on each of the games of the created session or a subset of the games of the created session. Once committed to place wagers, the system operates to automatically place such committed wagers, thereby eliminating certain of the delays otherwise associated with a user of a client device manually placing a wager on a play of a game at a selected streaming device. For example, to address certain of the concerns of wagering on each individual game, a user of a client device places a $100 wager on a session that results in a $1 wagered on the next 100 plays of the game at the selected streaming device. In another example, a user of a client device places a $100 wager on a session that results in matching the wagers placed by the user of selected streaming device (until the $100 is depleted). Such a configuration of committing to placing multiple wagers at a single point in time and enabling the system to automatically place such wagers over an ensuing period of time enables the system of the present disclosure to synchronize the placement of such wagers to minimize certain of the timing challenges associated with wagering in a streaming environment caused by certain delays in streaming content between a selected streaming device and a live streaming platform and one or more client devices

In another embodiment wherein the viewer interfacing with a client device actively interacts with the live stream, following the viewer establishing and adequately funding a live streaming wagering account and accessing a live stream associated with a gaming session at a selected streaming device, the live streaming platform enables the viewer at the client device to place a bet on a play of a game or other event occurring at the selected streaming device independent of any bet placed by the user at the selected streaming device. In this embodiment, the system enables a wager to be placed by the viewer at the client device on any suitable event that may or may not occur in association with one or more plays of one or more games at the selected streaming device and/or independent of any such plays at the selected streaming device. That is, the live streaming platform enables the viewer at the client device to wager on different events occurring in association with the selected streaming device, such as, but not limited to, the type of wins occurring at the selected streaming device, the amount of wins/losses occurring at the selected streaming device, any changing in a credit meter of the selected streaming device, any bonus being hit or other game event to be trigger at the selected streaming device including the number of times the event happened. For example, the live streaming platform enables the viewer at the client device to place a wager that a three cherry wining symbol combination will occur in the next ten games played at the selected streaming device, during a session of gaming at the selected streaming device, over a period of time (e.g., one minute) of gaming at the selected streaming device, and/or during a time window (e.g. 1:01 pm until 1:03 pm) of gaming at the selected streaming device. In different embodiments, the system provides the entire win amount of any winning wager of the viewer to the viewer (to place another bet or transfer to the live streaming wagering account) or the system provides a portion of the win amount of any winning wager to the viewer to the viewer, such as by automatically gifting a portion of the win amount of the viewer to the user at the selected streaming device.

In another embodiment wherein the viewer interfacing with a client device actively interacts with the live stream, following the viewer establishing and adequately funding a live streaming wagering account and accessing a live stream associated with a gaming session at a selected streaming device, the live streaming platform enables the viewer to place a bet against one or more other viewers (and/or one or more users at one or more selected streaming devices). For example, the system enables a viewer to place a bet on which user will win an ongoing tournament. In this embodiment, if the wagered-on user does not win the ongoing tournament, then the viewer loses their wager. On the other hand, if the wagered-on user wins the ongoing tournament, then the system provides the viewer an award based on the lost wagers placed by one or more other viewer (and/or one or more users at one or more selected streaming devices) minus a percentage held by the system.

In different embodiments, the system of the present disclosure is configured to enable the play of any suitable game, such as a wagering game, a non-wagering casual game, and/or a non-wagering social game, occurring at a selected streaming device to be streamed to one or more viewers at one or more client devices. In certain embodiments, the game includes a play of a primary game, such as a primary wagering game, wherein the game triggering event includes the placement of a wager on the play of the primary game. In certain embodiments, the game includes a play of a secondary game, such as a free spin game, wherein the game triggering event occurs based on a displayed event associated with a play of a wagered on primary game. In certain embodiments wherein the game includes a secondary game, such as a free spin game, the game triggering event occurs based on an event independent of any displayed event associated with the play of the wagered on primary game. In various embodiments, the displayed play of the wagering game, the non-wagering casual game, and/or the non-wagering social game includes, but is not limited to: a play of any suitable spinning reels game, a play of any suitable wheel game; a play of any suitable card game such as blackjack, poker or baccarat; a play of any suitable keno game; a play of any suitable bingo game; a play of any suitable offer and acceptance game; a play of any suitable award ladder game; a play of any suitable puzzle-type game; a play of any suitable persistence game; a play of any suitable selection game; a play of any suitable cascading symbols game; a play of any suitable ways to win game; a play of any suitable scatter pay game; a play of any suitable coin-pusher game; a play of any suitable elimination game; a play of any suitable stacked wilds game; a play of any suitable trail game; a play of any suitable bingo game; a play of any suitable video scratch-off game; a play of any suitable pick-until-complete game; a play of any suitable shooting simulation game; a play of any suitable racing game; a play of any suitable promotional game; a play of any suitable high-low game; a play of any suitable lottery game; a play of any suitable number selection game; a play of any suitable dice game; a play of any suitable skill game; a play of any suitable partial skill game; a play of any suitable auction game; a play of any suitable reverse-auction game; a play of any suitable group game; and/or a play of any other game of the present disclosure. In certain embodiments, the awards available to be won by one or more viewers of one or more client devices in association with one or more wagers placed by such viewers of such client devices (as well as the awards available to the user of the selected streaming device) include, but are not limited to, one or more of: a quantity of monetary credits, a quantity of non-monetary credits, a quantity of promotional credits, a quantity of player tracking points, a progressive award, a modifier, such as a multiplier, a quantity of free plays of one or more games, a quantity of plays of one or more secondary or bonus games, a multiplier of a quantity of free plays of a game, one or more lottery based awards, such as lottery or drawing tickets, a wager match for one or more plays of one or more games, an increase in the average expected payback percentage for one or more plays of one or more games, one or more comps, such as a free dinner, a free night's stay at a hotel, a high value product such as a free car, or a low value product, one or more bonus credits usable for online play, a lump sum of player tracking points or credits, a multiplier for player tracking points or credits, an increase in a membership or player tracking level, one or more coupons or promotions usable within and/or outside of the gaming establishment (e.g., a 20% off coupon for use at a convenience store), virtual goods associated with the system, virtual goods not associated with the system, an access code usable to unlock content on an internet.

It should be appreciated that in certain embodiments which enable one or more viewers of one or more client devices to interact with one or more live streams (e.g., via live chatting and/or via wagering on one or more events associated with the selected streaming device generating at least part of the live stream), the live streaming platform accounts for this interaction in determining any additional information to display as part of the live stream. For example, the additional information incorporated as part of a live stream includes data associated with one or more bets placed in association with a user at a selected streaming device, such as the amount won by viewers for back betting on a user at a selected streaming device or the win and loss records for back betting sports wagers placed by viewers in association with a user at a selected streaming device. In such embodiments wherein one or more viewers interact with the live stream, since the selected streaming device is the entity that encodes the video stream, any activities or event occurring on the live streaming platform must be sent to the selected streaming device to update any graphical elements rendered in the video stream. For example, if a viewer sends a gift to a user at the selected streaming device, then the live streaming platform generates an award message. In this example, either the live streaming platform sends the generated message to the selected streaming device, or the selected streaming device actively polls the live streaming platform for any outstanding notification messages. Upon receipt of a notification message, the selected streaming device acts upon the notification, such as displaying a notification that only the user at the selected streaming device can see, rendering of one or more notifications onto the game itself, and/or rendering of one or more notifications as part of the video stream (which are viewable by viewers and may or may not be seen by the user at the selected streaming device).

In various embodiments, as mentioned above, in addition to facilitating the streaming content being delivered to one or more client devices, the systems enable multiple users of multiple devices the opportunity to sequentially or simultaneously partake in a community game which is streamed to one or more client devices. In these embodiments, the system captures certain content generated in association with the community game and broadcasts such captured content to one or more users of one or more client devices viewing the community game. In certain such embodiments, in facilitating the streaming of content being delivered to one or more client devices, the system enables different devices associated with different users participating in the community game to operate as a streaming device at different points in time prior to, during and/or after a play of the community game. In certain additional or alternative embodiments, the system enables, at different points in time prior to, during and/or after the play of the community game, one or more participants in the community game (and/or users of client devices viewing the community game) the opportunity to interact with one or more of the participants of the community game. In certain such embodiments, the system captures such interactions and broadcasts such captured interactions to one or more users of one or more client devices viewing the community game. Such a configuration of employing a community game in a streaming environment overcomes certain physical constraints associated with community gaming (e.g., the limited amount of space casinos have for EGMs that provide community games as well as the disconnect between users of these community games when the EGMs are spaced far enough apart from each other that the users are unable to interact with each other). Such a configuration of employing a community game in a streaming environment offers an avenue to incorporate, independent of user locations, captured content of certain users as well as interactions between different users.

In certain embodiments, the multiple participant event takes the form of a streamed play of a community game participated in by one or more users. In certain such embodiments, the users participate sequentially in the streamed community game in which the system facilitates the transition from one participant in the community game to the next participant in the community game. In certain other embodiments, the users participate simultaneously in the streamed community game in which the system coordinates which participants turn to make zero, one or more inputs in the community game (or otherwise undertake zero, one or more actions (or inactions)) to potentially influence the results of the community game. It should be appreciated that while generally described as a community game including multiple participants, in certain embodiments, the community game includes a single participant with or without the availability of that single participant to invite others to join the community game.

In certain embodiments, the system periodically determines whether to trigger a multiple participant event and begin selecting participants. In certain such embodiments in which the multiple participant event takes the form of a community game, the system monitors for an occurrence of a community game triggering event which results in the identification of one or more users to participate in a play of the community game.

In certain embodiments, a community game triggering event occurs at a certain point in time, such as at a set point in time (e.g., Saturday at 10:00 PM) or at a set interval of time (e.g., every thirty minutes). In certain embodiments, a community game triggering event additionally or alternatively occurs when a certain quantity of events occur at one or client devices and/or streaming devices in communication with the live streaming platform (e.g., when a certain amount of play happens at a streaming device). In certain embodiments, a community game triggering event additionally or alternatively occurs responsive to one or more inputs by an operator, such as when a gaming establishment operator and/or an online casino operator makes one or more inputs to trigger a community game. In certain embodiments, a community game triggering event additionally or alternatively occurs when one or more users of one or more client devices (and/or a streaming device) request to trigger a community game. In certain embodiments, a community game triggering event additionally or alternatively occurs when a threshold quantity, such as majority, of users of client devices (and/or a streaming device) vote to trigger a community game. In certain embodiments, a community game triggering event randomly occurs. In certain embodiments, a community game triggering event occurs at the beginning of a streaming session when a device is selected to operate as a streaming device of that streaming session. In certain embodiments, a community game triggering event occurs following an occurrence of a community game termination event when one community game ceases to be played and another community game may begin. In certain embodiments, a community game triggering event occurs based on one or more displayed events occurring in association with a play of a game occurring at a device operating as the streaming device. In certain embodiments, a community game triggering event occurs independent of any displayed events occurring in association with any plays of any games occurring at any device operating as the streaming device and/or any device operating as a client device.

In certain embodiments, if the system determines not to trigger the multiple participant event (i.e., no community game triggering event occurred), the system continues to periodically determine whether to trigger the multiple participant event and begin selecting participants. On the other hand, if the system determines to trigger the multiple participant event (i.e., a community game triggering event occurred), the system monitors for one or more events that occur (or fail to occur) that result in identifying one or more users to participate in the multiple participant event. In such embodiments in which the multiple participant event takes the form of a community game, following the triggering of the community game, the system periodically determines for an occurrence of a community game participant selection event to assembly one or more contestants for an upcoming play of the community game.

In certain embodiments, the community game triggering event and each occurrence of the community game participant selection event are separate events. In these embodiments, the community game triggering event occurs and then the system monitors for one or more occurrences of the community game participant selection event. In certain embodiments, the community game triggering event and an initial occurrence of the community game participant selection event are the same event. In these embodiments, the system determines a user to participate in the community game in which this determination qualifies as an occurrence of the community game triggering event.

In certain embodiments, a community game participant selection event occurs when one or more users of one or more client devices (and/or a streaming device) request to participate in a community game. In certain such embodiments, the request of certain users does not translate to participation in the community game (and the request of certain other users translates to participation in the community game). In certain embodiments, a community game participant selection event additionally or alternatively occurs when a threshold quantity, such as majority, of users of client devices (and/or a streaming device) vote to participate in the community game. In certain embodiments, a community game participant selection event additionally or alternatively occurs responsive to one or more inputs by an operator, such as when a gaming establishment operator and/or an online casino operator makes one or more inputs to assemble one or more users for a community game. In certain embodiments, a community game participant selection event occurs based on one or more displayed events occurring in association with a play of a game occurring at a device operating as the streaming device. In certain embodiments, a community game participant selection event occurs independent of any displayed events occurring in association with any plays of any games occurring at any device operating as the streaming device and/or any device operating as a client device.

In certain embodiments, if the system determines that no community game participant selection event occurred, the system continues to monitor for an occurrence of a community game participant selection event. In certain of these embodiments, the lack of the occurrence of a community game participant selection event does not otherwise affect one or more streaming sessions currently occurring in association with one or more streaming devices.

On the other hand, if the system determines that community game participant selection event occurred, the system proceeds with determining which devices and/or which users of which devices should participate in the triggered community game. In certain embodiments, upon an occurrence of a community game participant selection event, all users are eligible to participate in a streamed community game. In certain embodiments, upon an occurrence of a community game participant selection event, all users up to a designated quantity of users are eligible to participate in a streamed community game. For example, upon an occurrence of a community game participant selection event, the system selects the first ten users viewing a streaming session to be contestants in a community game.

In certain embodiments, as part of the selection of a user at a device to participate in a community game, the system determines which users and/or which devices are eligible to participate in a streamed community game (and/or determines which of such devices are further eligible to operate as a streaming device for at least part of the streamed community game). In these embodiments, in determining a user to participate in a streamed community game and/or in determining a device to operate as a streaming device for at least part of the streamed community game, the system employs one or more eligibility factors to determine which users and/or which devices will play a role in a streamed community game. Put differently, prior to the play of a community game, the system determines the universe of users available to participate in the community game and which devices of such users are available that are capable of operating as the streaming device for at least part of such a community game.

In certain embodiments, the eligibility of a user to participate in a community game and/or the eligibility of a device to operate as a streaming device for at least part of a streamed community game is based on one or more actions (and/or inactions) of a user (and/or other users). In these embodiments, different actions (and/or inactions) undertaken by a user at a device factor into whether or not that user is eligible to participate in the community game and/or that device is eligible to operate as a streaming device for at least part of the community game. In certain such embodiments, the eligibility is determined based on one or more inputs received by the user indicating they want to participate in the streamed community game and/or participate in the streamed community game as a user of a streaming device. In certain such embodiments, the eligibility is determined based on a buy-in amount to participate in the streamed community game provided by the user and/or a buy-in amount to participate in the streamed community game as a user of a streaming device. In certain of these embodiments, different users have different buy-in amounts determined based on one or more attributes of the individual user.

In certain embodiments, the system enables a user of a device to opt-out of (or alternatively opt-into) participating in the streamed community game. In certain embodiments, the system enables a user to make one or more inputs, such as inputs via an externally controlled interface displayed by an EGM (i.e., a service window) or via a mobile device linked to the device, to opt-out (or alternatively opt-into) when they start a session at a streaming capable device, such as a streaming capable EGM. In certain embodiments, the system enables a user to associate an opt-out (or opt-in) selection with an account maintained for the user, such as a player tracking account, such that following the user making the selection once, the selection applies to future community games following the user logging into their account from the device.

In certain additional or alternative embodiments, the eligibility of a user to participate in a community game and/or the eligibility of a device to operate as a streaming device for at least part of a streamed community game is based on the device. In these embodiments, different devices have different settings and/or capabilities that determine whether or not that device is eligible to operate as a streaming device for at least part of a streamed community game. For example, a device including (or excluding) certain of the above-described components employed to operate as a streaming device (e.g., a video capture component to operate with a live streaming platform and/or a camera to capture images of a user of the device) dictates whether or not that device may be eligible to operate as a streaming device for at least part of a streamed community game. In another example, a device with certain games available (and/or of a certain game theme) is eligible to operate as a streaming device for at least part of a streamed community game but another device without those games available (and/or of a different game theme) is ineligible.

In certain additional or alternative embodiments, the eligibility of a user to participate in a community game and/or the eligibility of a device to operate as a streaming device for at least part of a streamed community game is based on one or more attributes or preferences of a user of that device. In certain embodiments, the system associates different users with different eligibilities to participate in a community game and/or participate in a community game as a user of a streaming device. In certain instances, the eligibility to associate with a user is based on one or more of whether or not the user is part of a group (e.g., is the user on a list of friends of another participant), whether or not the user has an account with a gaming establishment management system (e.g., a player tracking account maintained by a patron management system), a ranking of any account the user has with the gaming establishment management system (e.g., users of a certain player tracking status, such as gold level users, are eligible while users of a different player tracking status, such as bronze level users, are ineligible), whether or not the user has an account maintained by the live streaming platform, whether or not any account is configured to enable the placement of wagers in association with one or more streams, a balance of an account maintained by the live streaming platform (e.g., users associated with an account having a balance at or above a threshold value are eligible while users associated with an account having a balance below the threshold value are ineligible), a status of the user in the streaming environment, an age of the user (detectable by a camera of the device of the user and/or an age verification procedure associated with one or more accounts of the user), and/or a location of the user.

In certain additional or alternative embodiments, the eligibility of a user to participate in a community game and/or the eligibility of a device to operate as a streaming device for at least part of a streamed community game is based on whether or not a wager was placed at that device (and/or whether a wager was placed on the community game). In certain additional or alternative embodiments, the eligibility of a user to participate in a community game and/or the eligibility of a device to operate as a streaming device for at least part of a streamed community game is based on a wagering history of a user of that device (and/or occurring at that device independent of the user). In certain additional or alternative embodiments, the eligibility of a user to participate in a community game and/or the eligibility of a device to operate as a streaming device for at least part of a streamed community game is based on one or more placed wagers with (or against) a user of a currently employed streaming device over a period of time, such as during the current streaming session, over a subset of past streaming sessions associated with a period of time or over all past streaming sessions regardless of when they occurred. In certain instances, the eligibility is based on a quantity of wagers made from that device and/or an amount of the wagers made from that device. In certain other instances, the eligibility is based on a quantity of wagers made from that device over a period of time and/or an amount of the wagers made from that device over the period of time.

In certain embodiments the eligibility of a user to participate in a community game and/or the eligibility of a device to operate as a streaming device for at least part of a streamed community game is based on one or more tracked events or activities occurring in association with one or more users of devices associated with the live streaming platform. In certain embodiments the eligibility of a user to participate in a community game and/or the eligibility of a device to operate as a streaming device for at least part of a streamed community game is based on one or more tracked events or activities occurring in association with one or more of the eligible devices.

In certain embodiments, which events and/or activities are tracked is based on one or more game play events occurring in associated with such devices. In these embodiments, different game play events factor into whether or not a user is selected to participate in a community game and/or a device is selected to operate as a streaming device for at least part of a streamed community game. For example, the system tracks for the random occurrence of wins associated with a value above a certain amount (e.g., wins that create a handpay condition) and/or the random occurrence of winning outcomes from a certain category (e.g., royal flush wins). In other examples, the system tracks for the random occurrence of a streak of outcomes (e.g., a winning streak or a losing streak), the random triggering of a bonus game and/or the random triggering of a progressive award. In different instances, the tracked events and/or activities associated with one or more game play events include, but are not limited to: a placement of a wager (regardless of the wager amount); a placement of a side-wager (regardless of the side-wager amount); a wager on a number of paylines; a wager on a designated payline; a wager on a number of ways to win; a speed of play by a user; a change in a speed of play by a user; a betting pattern by a user; a change in betting pattern by a user; a change in a type of game played; an amount won; an amount lost; a quantity of games played; a quantity of games won; a quantity of games lost; an amount of a theoretical win; an amount of a theoretical hold; an activation of a reel; a stopping of a reel, an activation of a plurality of reels; a stopping of a plurality of reels, a generation of any outcome (or a designated outcome); a generation of any outcome (or a designated outcome) associated with an award; a generation of any outcome (or a designated outcome) associated with an award over a designated value; a generation of an outcome on a designated payline; a generation of an outcome in a scatter configuration; a generation of a winning way to win; a generation of a designated symbol or symbol combination; a generation of a designated symbol or symbol combination on a designated payline; a generation of a designated symbol or symbol combination in a scatter configuration; a payment of an award amount; a triggering of a play of a secondary game; an activation of a secondary display; an activation of a community award generator; and/or a generation of any outcome (or a designated outcome) in a secondary game. In these embodiments, any game play event occurring in association with one or more plays of one or more games occurring in association with one or more devices may be tracked by the system to potentially be employed in the selection of a participant in the community game and/or the selection of a device as a streaming device for at least part of the community game.

In certain embodiments, which events and/or activities are tracked is based on one or more non-game play events occurring in association with such devices. In these embodiments, different events that are separate from any plays of any games of such devices factor into whether or not a user is selected to participate in a community game and/or a device is selected to operate as a streaming device for at least part of a streamed community game. In other words, the tracked events include one or more events which occur in association with a device independent of any plays of any games of such as device. In different instances, the system tracks deposits of funds at a device, an identification of a user at a device, an amount of player tracking points redeemed or otherwise spent over a period of time, an amount of virtual currency redeemed or otherwise spent over a period of time, and/or interactions between a user of a device and another user. In such embodiments, any non-game play event occurring in association with a device may be tracked by the system to potentially be employed in the selection of a user to participate in a community game and/or the selection of a device to operate as a streaming device for at least part of a streamed community game.

In certain embodiments, which events and/or activities are tracked is based on one or more actions (and/or inactions) of a user of the device. In these embodiments, different actions (and/or inactions) undertaken by a user at a device factor into whether or not a user is selected to participate in a community game and/or a device is selected to operate as a streaming device for at least part of a streamed community game. In these embodiments, any activity occurring in association with a user of a device may be tracked by the system to potentially be employed in the selection of a user to participate in a community game and/or the selection of a device to operate as a streaming device for at least part of a streamed community game.

It should be appreciated that any suitable event which occurs in association with a device and/or any suitable quantifiable action a user takes (or does not take) in association with the device may be tracked by the system of the present disclosure and employed in the selection of a user to participate in a community game and/or the selection of a device to operate as a streaming device for at least part of a streamed community game. That is, data associated with any trackable input at a device and/or any trackable output from the device which occurs in association with one or more plays of one or more games played at the device, or occurs independent of any games played at the device may be tracked in accordance with the system of the present disclosure. As such, any suitable event, series of events or lack of an event may qualify as an occurrence of an event and/or activity utilized to potential enable a user to be selected to participate in a community game and/or a device to be selected to operate as a streaming device for at least part of a streamed community game.

In certain additional or alternative embodiments, the eligibility of a user to participate in a community game and/or the eligibility of a device to operate as a streaming device for at least part of a streamed community game is based on one or more outcomes donated to another user over a period of time. In certain instances, the eligibility associated with the user at the device is based on amount of the outcomes donated and/or which outcomes are donated. In certain additional or alternative embodiments, the eligibility of a user to participate in a community game and/or the eligibility of a device to operate as a streaming device for at least part of a streamed community game is based on one or more amounts of money donated to another user over a period of time. In certain instances, the eligibility associated with the user at the device is based on amount of money donated and/or the frequency of giving money. In certain embodiments, the eligibility of a user to participate in a community game and/or the eligibility of a device to operate as a streaming device for at least part of a streamed community game is based on one or more displayed events occurring in association with a play of a game occurring at that device. In certain embodiments, the eligibility of a user to participate in a community game and/or the eligibility of a device to operate as a streaming device for at least part of a streamed community game is based on one or more random events. In certain embodiments, the eligibility of a user to participate in a community game and/or the eligibility of a device to operate as a streaming device for at least part of a streamed community game is independent of any displayed events occurring in association with any plays of any games occurring at that device.

In certain additional or alternative embodiments, the eligibility of a user to participate in a community game and/or the eligibility of a device to operate as a streaming device for at least part of a streamed community game is based on a user of a device following another user (and/or a gaming establishment) on one or more social media sites. In certain instances, the eligibility associated with the user at the device is based on the length of time following the other user (and/or a gaming establishment), the quantity of social media activity (e.g., likes or shares of content associated with the other user) and/or the quantity of social media sites which the other user (and/or gaming establishment) is being followed on. In certain additional or alternative embodiments, the eligibility of a user to participate in a community game and/or the eligibility of a device to operate as a streaming device for at least part of a streamed community game is based on a user of a device subscribing to a streaming channel associated with another user. In different embodiments, such a subscription costs an amount of money (which is funded by the account associated with the user of the device maintained by the live streaming platform). In certain instances, the eligibility associated with the user at the device is based on the amount of money spent subscribing and/or the length of time subscribing. In certain additional or alternative embodiments, the eligibility of a user to participate in a community game and/or the eligibility of a device to operate as a streaming device for at least part of a streamed community game is based on an amount of time spent viewing a stream over a period of time. In different embodiments, such viewing can be of live streams and/or recorded streams. In certain instances, the eligibility associated with the user at the device is based on the length of time viewing the content and/or which streams are viewed.

In certain additional or alternative embodiments, the eligibility of a user to participate in a community game and/or the eligibility of a device to operate as a streaming device for at least part of a streamed community game is based on another user at another device. In certain such embodiments in which the eligibility is based on another user of another device, a user at a currently employed streaming device determines the eligibility of one or more users at one or more other devices to participate in the community game and/or potentially operate as the streaming device for part of the community game.

In certain embodiments in which the eligibility is based on another user at another device, the system enables a user selected to participate in the community game to invite other users, such as users whom are on one or more lists of friends of the selected user, to participate in the community game. In these embodiments, the system enables the invited users to accept or decline the invitation to participate in the community game. In certain embodiments, the invited users that accept the invitation participate in the community game as if they were otherwise selected based on any applicable eligibility factors. In these embodiments, the invited users may, as described in more detail below, interact with other users in the community game lobby, win awards in the community game, place wagers on the community game, place side wagers against other participants in the community game, and otherwise participate fully in the community game. In certain embodiments, the system limits the participation in the community game of the invited users that accept the invitation. For example, the system enables invited users to provide social aspects to the community game (e.g., cheer on a friend) without enabling such invited users to win any awards in the community game. In another example, the system enables invited users to win a portion of any awards won by in the community game by the selected user that invited them to the community game.

Accordingly, in certain embodiments, following an occurrence of a community game triggering event and responsive to an occurrence of a community game participant selection event associated with a first user of a first device, the system enables the first user of the first device to participate in a community game streamed to a client device as part of a live stream. In these embodiments, responsive to a second, different user of a second, different device having a designated relationship with the first user and independent of any occurrence of any community game participant selection event associated with the second, different user, the system associates the second, different user with the community game.

In certain embodiments, the eligibility of a user to participate in a community game and/or the eligibility of a device to operate as a streaming device for at least part of a streamed community game is based on an operator of the live streaming system. In these embodiments, the operator of the live streaming system determines, for one or more devices and/or one or more users at such device devices, an eligibility to participate in a community game and/or to operate as a streaming device for at least part of a streamed community game.

It should be appreciated that any suitable factor associated with a user of a device and/or the device may determine whether or not that user is eligible to participate in a community game and/or whether that device is eligible to operate as a streaming device for at least part of a streamed community game. It should be further appreciated that different combinations of factors determine the eligibility of a user to participate in a community game and/or the eligibility of a device to operate as a streaming device for at least part of a streamed community game and one or more of these factors change over time, the eligibility of a user to participate in a community game and/or the eligibility of a device to operate as a streaming device for at least part of the community game may also change such that a user and/or a device that was previously ineligible becomes eligible (or alternatively a user and/or a device that was previously eligible becomes ineligible).

In different embodiments, one or more occurrences of the community game participant selection event determine the universe of users and/or devices available for the community game. That is, following one or more community game participant selection events (which may be the same or different for different users and/or different devices), the system employs zero, one or more of the different available qualifiers to determine which users of which EGMs located within a casino and operable with both a live streaming platform and a community game host are eligible to participate in a community game and/or eligible to operate as a streaming device for at least part of a streamed community game to stream content to a viewer at a client device. Moreover, following the community game participant selection events, the system employs zero, one or more of the different available qualifiers to determine which users of which devices independent of a gaming establishment, such as devices interfacing with a remote game server of an online casino, and operable with both the live streaming platform and the community game host are eligible to participate in a community game and/or eligible to operate as a streaming device for at least part of a streamed community game to stream content to a viewer at a client device. In certain such embodiments, the system includes a community game host (configured to, amongst other actions, select participants of the community game and orchestrate at least part of the community game) separate and distinct from the live streaming platform. In certain other embodiments, the community game host is part of the live streaming platform.

In certain embodiments, following the selection of a user to participate in the community game, the system causes the device of the selected user to display a community game lobby. In addition to displaying any information associated with the upcoming play of the community game (e.g., displaying a countdown timer until the community game will be played), the community game lobby includes content associated with one or more selected users. In these embodiments, the community game lobby operates as a staging area where selected users may view information regarding other participants in the community game. In certain such embodiments, as users become eligible to participate in the community game, the system enters such users into the community game lobby. Such embodiments provide a random assortment of users in the community game lobby.

In certain embodiments, to foster more interactions between users in the lobby, the system employs certain groupings of users for the community game such that as a user becomes eligible to participate in the community game, the system first determines if that user is part of an applicable grouping of users. For example, the system forms groups for the community game based on any suitable differentiating factor (e.g., the system employs user preferences as a differentiator such that users that are known by the system to be friends, like sports and/or prefer poker games are grouped together in a community game lobby). In these embodiments, if the system determines that a user is part of an applicable grouping of users, the system enters such users into the applicable community game lobby. If not, the system forms another grouping of users and places the user into a community game lobby for that formed grouping (or alternatively places that user into a general community game lobby not otherwise differentiated).

In certain embodiments, while one or more selected users wait in the community game lobby, the system incorporates content of one or more of such selected users in association with part or all of the broadcast to the viewers of client devices and/or displayed to the users selected to participate in the community game. In such embodiments, as one or more users are selected to participate in the community game, the system sequentially adds such users to the lobby.

In certain embodiments, for selected users added to the lobby (and/or participating in the community game), the system displays certain information associated with one or more users. In different embodiments, the displayed information includes, but is not limited to, the user's name, the user's nickname or username, the user's gaming history (e.g., total wagered and/or total won), any settings of the device of the user (e.g., are the audio settings of the user's device currently muted), one or more statuses of the user (e.g., club member status and level and/or achievements), and/or if the user part of any groups or memberships (e.g., whether that user is included in one or more lists of friends, lists of blocked users, lists of sports fan, and/or list of high rollers).

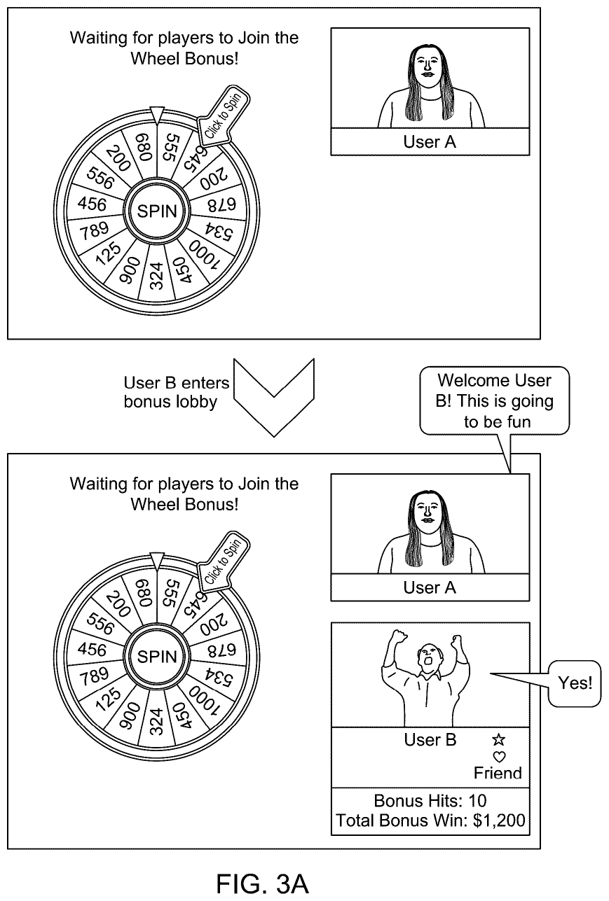

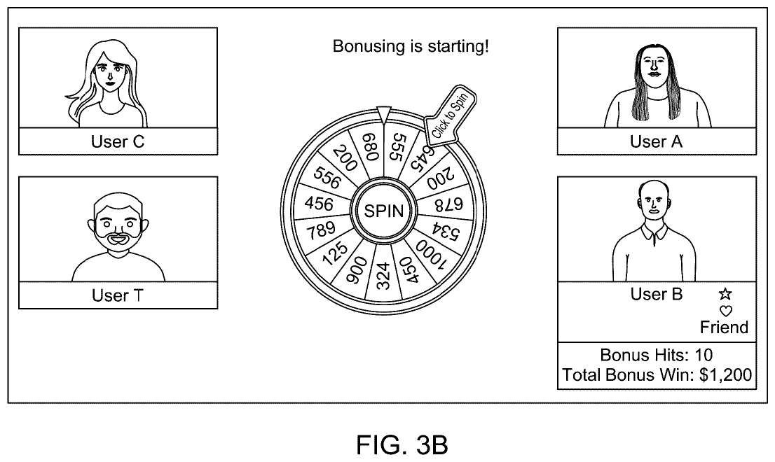

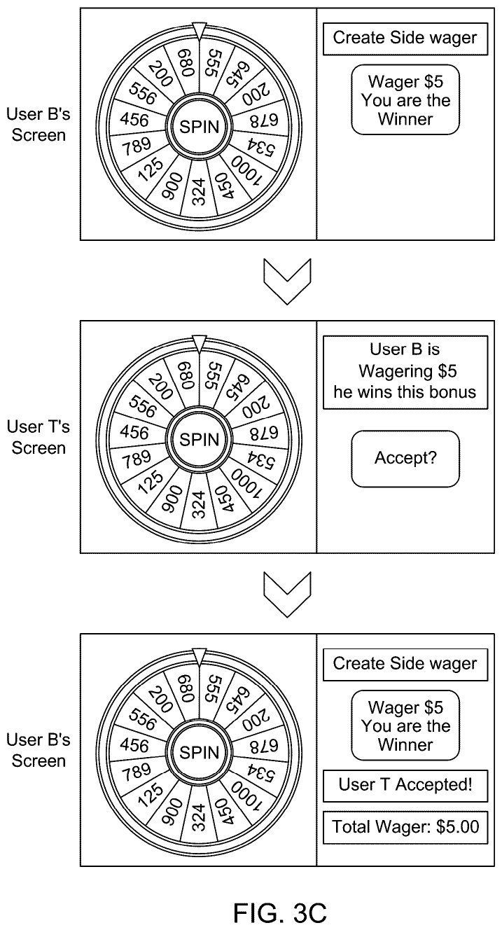

In certain embodiments, for selected users added to the lobby (and/or participating in the community game), the system displays audio/video content of the selected user. In such embodiments, the system employs one or more audio/video capture devices associated with the device of one or more selected users (e.g., a camera of the devices being respectively engaged by one or more selected users) and/or independent of such selected users (e.g., a security camera of a gaming establishment) to capture audio/video data of one or more selected users to incorporate into part or all of the live stream delivered to one or more client devices and/or displayed to the users selected to participate in the community game. For example, as seen in FIG. 3A, following the display of the lobby of the community game including User A whom was selected to participate in the community game, the system transitions to also display User B entering the lobby (based on being selected to participate in the community game). As seen in FIG. 3A, the system utilizes audio/video data associated with both User A and User B in the lobby. Additionally and as seen in FIG. 3B, as more users are selected to participate in the community game, the system adds audio/video data associated with such additional users. In these examples, as indicated above, the system displays certain information associated with certain of the users (e.g., for User B, the system displays: (i) a gold star indicating that User B is a gold level member of a player tracking system, (ii) a heart indicating that User B is included on a list of friends of the particular viewer of the lobby of this example, and (iii) User B's gaming history in the community game).

In certain embodiments, in association with displaying content of one or more selected users, the system enables such selected users in the lobby to interact with each other (and/or with users of client devices viewing the lobby). In certain such embodiments, the interactions include a live chat in which selected users in the lobby type messages to each other (and/or with users of client devices viewing the lobby). In certain such embodiments, the interactions additionally or alternatively include audio/video interactions in which such users in the lobby talk to each other (and/or with users of client devices viewing the lobby). In certain such embodiments, the interactions include one user making one or more inputs to be added to a list of friends of another user (which, in certain instances, may increase that other user's standing in the live streaming environment). In certain embodiments, in formatting the content to be displayed to one or more devices in association with the community game, the system employs a picture-in-picture overlay (e.g., a widget displayed over an iGaming game) to display content generated for the community game lobby and/or the community game, enable users to participate in the community game, and interact with other participants in the community game (and/or viewers of the community game from client devices). In certain other embodiments, in formatting the content to be displayed to one or more devices in association with the community game, the system utilizes an externally controlled interface (i.e., a service window) to display content generated for the community game lobby and/or the community game, enable users to participate in the community game, and interact with other participants in the community game (and/or viewers of the community game from client devices). In certain embodiments, rather than displaying the content of the selected users, the system employs audio data of content of such selected users to enable users of client devices to listen to the participants in the community game lobby.

In certain embodiments, the system enables a selected user to opt-out of (or alternatively opt-into) any captured audio/video data of that user being broadcast in the lobby (and/or during the live stream of the community game). In certain embodiments, the system enables a user to make one or more inputs, such as inputs via an externally controlled interface displayed by an EGM (i.e., a service window) or via a mobile device linked to the device, to opt-out (or alternatively opt-into) any captured audio/video data of that user being broadcast in the lobby (and/or during the live stream of the community game). In certain embodiments, the system enables a user to associate an opt-out (or opt-in) selection with an account maintained for the user, such as a player tracking account, such that following the user making the selection once, the selection applies to future lobbies and/or community games following the user logging into their account from the device.

In certain other embodiments, rather than utilizing audio/video data of one or more selected users in the lobby to source content for the stream, the system enables one or more of such selected users to choose an avatar (or access a previously chosen avatar) to represent them in the lobby and/or during live stream of the community game. In certain embodiments, the system enables a selected user to disable the utilization of audio/video data at any time (in which case the system reverts to an avatar to represent the user in the lobby and/or during live stream of the community game). In certain embodiment, the system automatically adjusts an avatar's behavior based upon the activity of the community game. In certain additional or alternative embodiments, the system enables the user to provide a voice for the avatar. In certain other embodiments, the system enables a selected user to upload or otherwise access a photograph or scan of themselves and the system uses artificial intelligence to generate an avatar based upon their likeness (and, in certain instances, the behavior of the avatar may be adjusted based upon the activity of the community game, words spoken by the selected user during the community game and/or upon a command by the user using one or more pre-defined commands).

In certain embodiments, the interactions between different selected users additionally or alternatively include enabling such users to place side-wagers with each other (and/or with users of client devices viewing the lobby). In certain embodiments, while in the lobby (and/or during the play of the community game), the system enables selected users to wager against each other about the outcome of the community game. For example, as seen in FIG. 3C, while in the lobby, User B and User T set up a side-wager between them on who will perform better in the community game. In this example, User B offers User T a side-wager and User T accepts. In different embodiments, the side-wager may be on any wagerable aspect of the community game including, but not limited to, an outcome of the community game, an outcome for part of the community game (e.g., the result of a single spin for a specific user, will any user/a specific user obtain a royal flush outcome or win a progressive award during the community game), and/or the amount won during the community game being above (or below) a specific value.

In certain embodiments, the system enables one selected user to choose to offer the side wager to one, more than one or all of the other users in the community game. In certain embodiments, the system enables a selected user to choose to offer the side wager only to determined friends (e.g., selected users on a list of friends and/or users of client devices on a list of friends). In these different embodiments, the system enables the user that offered a side wager to deny or otherwise deactivate one or more offers, such as disabling the acceptance of offers after a certain quantity of offers have been accepted.

In certain embodiments, the amount won is the amount the other user contributed to the side-wager (e.g., two users each put up $5 for a side-wager against each other on a portion of the community game and the winning user wins $10 made up of the $5 that user contributed and the $5 the other user contributed). In certain embodiments, the amount won from a side wager is the total of all side wagers placed with the system splitting the win amount evenly amongst those who had the winning wager. In certain such embodiments, the system charges a vigorish on the side wager and the amount remaining (after paying the vigorish) is eligible to be distributed to the winners of the side wager. In another embodiment, if multiple users each win the side wager, the system distributes the win amount to each user proportional to the amount they wagered. For example, if User A wagered $10 that User X would win the community game, User B wagered $5 that user X would win the community game, and the total side bet pool was $50, then User A wins ⅔ of the side bet pool, and User B wins ⅓ of the side bet pool (after any vigorish is accounted for).

Accordingly, in certain embodiments, following an occurrence of a community game triggering event, and an occurrence of a first community game participant selection event associated with a first user of a first device, the system enables the first user to offer a wager to a second, different user on an outcome of a community game streamed to a client device. In these embodiments, following the second, different user accepting the wager and a placement of the wager, and responsive to a receipt of first data associated with the community game, the system determines, based on the received first data associated with the community game, second data associated with a result of the wager.

In certain embodiments, while users wait in the lobby for the community game, the system enables such users to place wagers associated with one or more outcomes of the community game. Such wagers differ from the side-wagers described above because these wagers are against an operator (e.g., an operator of a gaming establishment associated with the live streaming platform and/or an operator of an online casino associated with the live streaming platform) as opposed to being against another user. In these embodiments, such wagers may be on any of any wagerable aspect of the community game, such as, but not limited to, who will become a participant in the community game, how many participants will be picked, an individual participant's performance during the community game (i.e., wagering both for and against an individual participant), and/or one or more outcomes of the community game.

In certain embodiments, the selection of users to participate in the triggered community game continues until the system determines to proceed to the triggered play of the community game. In certain embodiments, the play of the community game begins when at least a threshold quantity of participants in the community game have been selected. In these embodiments, the community game requires a minimum quantity of participants to begin the play of the community game such that until that minimum quantity is reached, the selected users wait in the community game lobby for additional users to be selected to participate in the play of the community game. For example, as seen in FIG. 3B, once four users have entered the lobby and are available to play the community game, the system proceeds with the triggered play of the community game. In certain such embodiments, if the threshold quantity of participants in the community game is not reached within a certain amount of time (e.g., from when the first user is selected to participate in the community game or since the last user was selected to participate in the community game) and/or a certain amount of games played, the system cancels the play of the community game and removes any selected users from the community game lobby. For example, after five minutes of enrolling users to participate in the community game, if only three users are selected to be contestants, the system cancels the upcoming play of the community game and removes these three users from the lobby. In certain embodiments, the play of the community game begins when a certain quantity of events occur at one or client devices and/or streaming devices in communication with the live streaming platform following the occurrence of the community game triggering event.

Upon the determination to begin the play of the community game, the system proceeds with the triggered community game. For the triggered community game, the system enables the selected users to participate, individually or collectively, in an attempt to achieve one or more goals or objectives, such as win an award. It should be appreciated that any suitable game available in association with a streaming device may be employed as the community game streamed to one or more users of one or more client devices.

In certain embodiments, the system randomly determines one or more awards for one or more participants in the community game independent of any inputs made by the participants in the community game. In certain such embodiments, the community game includes a ranking of participants in which, upon the conclusion of the community game, a highest (or lowest) ranked participant wins an award. For example, the community game takes the form of a free spin game that lasts for one minute. In this example, the user with the largest amount won during the free spins wins the award for the community game.

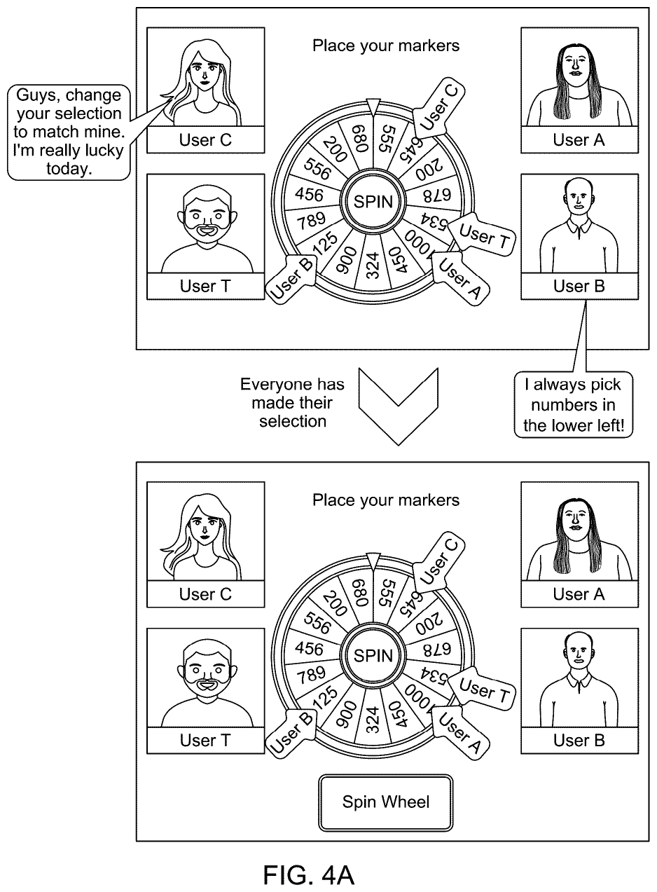

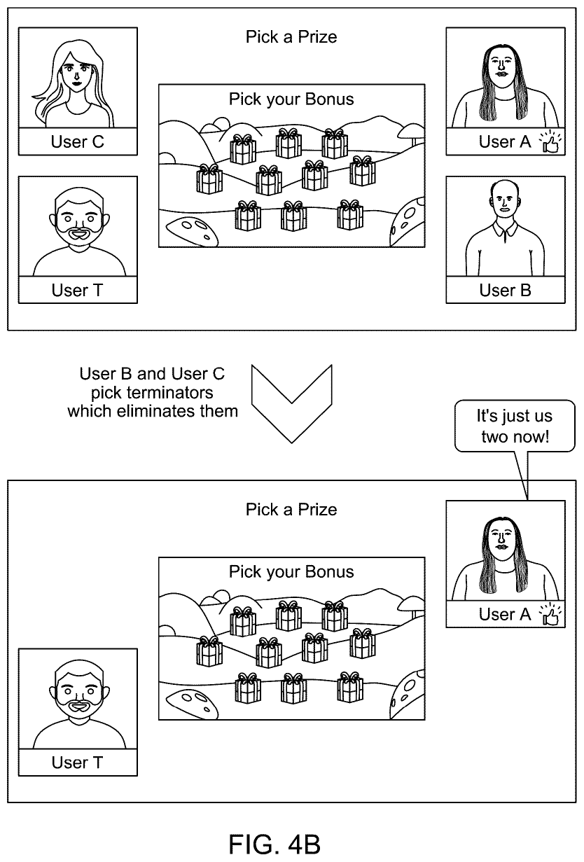

In certain embodiments, the system determines one or more awards for one or more participants in the community game at least partially based on one or more inputs by such users. In these embodiments, certain of the users interact with each other during the play of the community game and the system captures such interactions for broadcast as part of the live stream of the community game. For example, as seen in FIG. 4A, the community game takes the form of a spin of an award wheel in which different users place indicators around the award wheel (which subsequently spins and the award indicated by each user's respective indicator is that user's award for the community game). As also seen in FIG. 4A, different users interact with each other regarding the spin of the award wheel and the system incorporates these interactions as part of the live stream of the community game.

In certain embodiments in which the community game includes one or more determinations that affect the awards won by one or more of participants in the community game, the system proceeds with such determinations after each participant has made a required input, such as after each participant has placed an indicator at a position relative to an award wheel. In certain embodiments, the system proceeds with such determinations after a certain amount of time elapsed awaiting for participants to make the required input (e.g., a timer runs for each selected user which enables a selected user to exit the community game and reenter to make their selection prior to an expiration of the timer). In certain embodiments, the system proceeds with such determinations after the first user (or a designated quantity of users) makes the required input, thereby creating a frenzy amongst users to make the required input. In certain embodiments, the system randomly determines to proceed with such determinations, thereby creating a frenzy amongst users to make the required input prior to this randomly occurring event.

In certain embodiments in which the community game includes one or more determinations that affect the awards won by one or more of participants in the community game, the system enables a designated participant to initiate that determination and/or make an input in association with that determination. For example, if the community game takes the form of a spin of an award wheel, the system selects a designated participant to spin the award wheel. In another example, if the community game includes a skill element, such as driving a race car on a track, the system selects a designated participant to make zero, one or more quantifiable skill inputs, such as inputs to drive the race car. In various embodiments, such a designated participant may be any of the first user that entered the community game lobby, the highest-ranking user participating in the community game, the user with the most play today (or over a certain period of time), the user with the largest wager (or denomination placed) entering the community game, a randomly picked user, and/or the first user that made an input after a countdown expires. In certain embodiments, such a designated participant is based on a vote, such as a vote amongst the participants in the community game and/or a vote amongst users of client devices viewing the streamed community game. In these embodiments, the interactions between the users may pertain to determining whom to vote to be the designated participant. For example, if the community game includes a skill element, such as driving a race car on a track, in determining whom to vote for, participants might ask who has participated in the community game before and/or is good at making such skill inputs.

In certain embodiments, the community game includes the elimination of participants until one or more participants remain to win an award. In these embodiments, in addition to capturing any interactions between users for broadcast as part of the live stream of the community game, as users are eliminated, the system ceases to display any content associated with such eliminated users as part of the live stream of the community game. For example, as seen in FIG. 4B, the community game takes the form of an elimination selection game in which after a user picks a terminator selection, that user is removed from the community game and this process continues until a single user remains. As also seen in FIG. 4B, as each user is eliminated, the system removes the display of any content specific to that user from being part of the live stream of the community game.

In certain embodiments, the system employs part or all of one or more games occurring at the devices of the selected users to drive the community game. For example, the community game starts and selected participants play games on their devices in which the person with the highest winning amount after two minutes of game play gets to engage one or more inputs devices of their device to pick a prize in the community game. In certain other embodiments in which the system employs part or all of one or more games occurring at the devices of the selected users to drive the community game, the community game is associated with a play of a game occurring at a device of a selected user. For example, if the selected user is at an EGM utilizing a wheel, for the community game, a contestant (which may be different from the selected user) is asked to spin the wheel to determine an award for the community game.

In addition to employing part or all of one or more games occurring at the devices of the selected users to drive the community game, in certain embodiments, the system enables one or more devices of one or more selected users to operate as the streaming device for at least part of the community game. In these embodiments, following the determination to employ the device of a selected user to operate as the streaming device for at least part of the community game and a corresponding change, by the live streaming platform, of which device will operate as the streaming device, that device operates as the streaming device for part of the community game with the full suite of features and functionality described above. For example, users of client devices can back bet on the play of the community game and/or interact with the user of the selected device. In another example, during the community game, the viewers at client devices and fellow participants watch the community game unfold with the ability to chat and cheer on each other.

In certain other embodiments, the system enables certain of, but not each of, the above-described features and functionality available at the streaming device to the device operating as the streaming device for at least a portion of the community game. For example, the system enables the user of the device selected to operate as the streaming device for the community game but disables the chat and/or social media aspects during certain portions of the community game to prevent cheating (e.g., User A is picked to guess the price of a new car and the system turns off chat so that viewers at client devices cannot type and help User A with the answer).

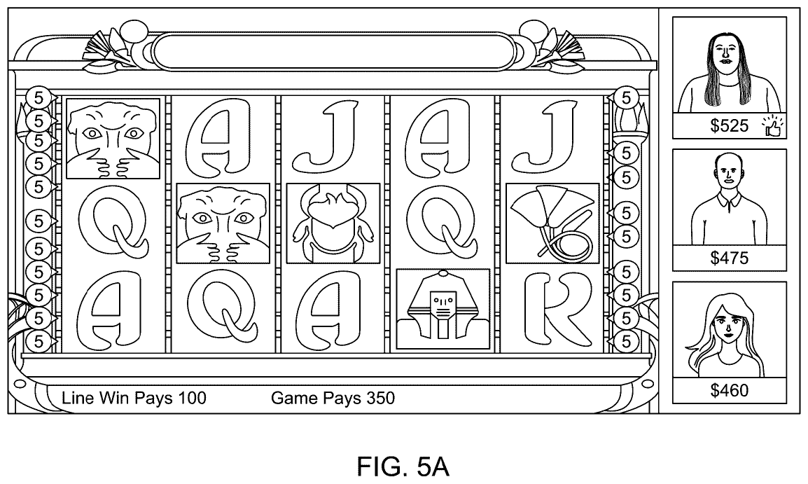

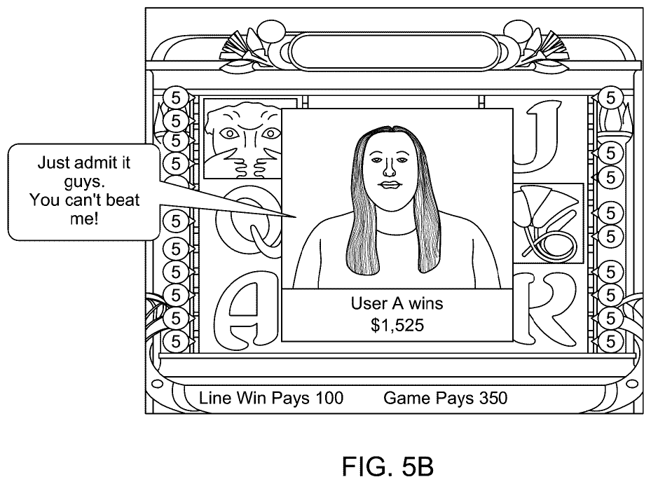

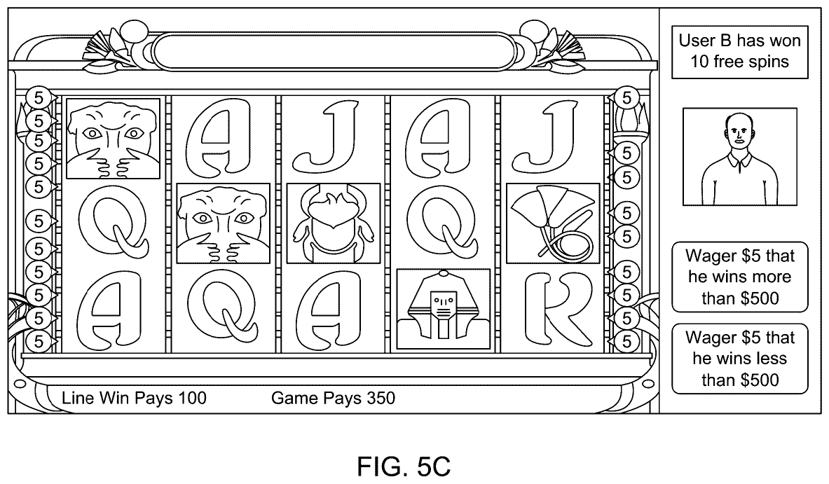

In certain embodiments, the system modifies the content specific to one or more participants in the community game based on the progress of the community game. In certain such embodiments in which the system employs a ranking of the participants in the community game, the system indicates the respective ranking by the scale of the video content and/or the presence of the video content of different users. For example, as seen in FIG. 5A, the system conveys the relative rankings of the different participants in the community game by showing the largest area of video content of the highest ranked participant at a designated position and then showing smaller areas of video content of the lower ranked participants at non-designated positions (or not showing any video content of certain low ranked participants).

Accordingly, in certain embodiments and following an occurrence of a community game triggering event, the system enables a plurality of selected users at a plurality of devices to each to participate in a community game and responsive to a receipt of first data associated with the community game, causes a client device to display a live stream comprising at least the community game. In these embodiments, the system additionally allocates, based on second data associated with the community game, at least a portion of the displayed live stream to include content captured of a designated user of the plurality of users selected to participate in the community game. Put differently, in certain embodiments, following an occurrence of a community game triggering event and during a first period of time which occurs responsive to a receipt of first data associated with a community game, the system causes a client device to display a live stream including a first portion of a community game and captured audio/video data of a first subset of the selected users. In such embodiments, during a second, different period of time which occurs responsive to a receipt of second data associated with the community game, the system causes the client device to display the live stream including a second, different portion of the community game and captured audio/video data of a second, different subset of the selected users.

In certain embodiments, the system determines zero, one or more awards for the community game and operates to make such awards available to zero, one or more selected users. In certain embodiments, one or more awards for the community game includes a static award, such as an amount of money added to one or more credit meters of one or more devices of one or more contestants in the community game or an amount of money transferred to one or more accounts associated with one or more contestants in the community game. In certain other embodiments, one or more awards for the community game includes a dynamic award, such as a percentage of the amount of money back bet on the community game. In different embodiments, any of the above-described awards available to be won from a play of a game occurring at a streaming device may additionally or alternatively be won by zero, one or more contestants in the community game. It should be appreciated that since certain funds cannot be directly paid to a selected user at an EGM or added to a credit meter of a personal gaming device accessing an iGaming game, the system employs certain required actions by the user to retrieve the funds. For example, certain monetary funds won during the community game which are directly credited to a user's cashless wagering account need to be retrieved by the user from their cashless wagering account and certain non-monetary funds (e.g., promotional funds) won during the community game and credited to a user's player tracking account promotional balance need to be retrieved by the user from their player tracking account.

In certain embodiments, following a determination of a winner of the community game, the system incorporates audio/video content of the winner into the live stream of the community game. In these embodiments, the system dedicates, for a certain amount of time, a portion of the live stream to that winner to exclusively (or semi-exclusively) provide content to the live stream. For example, as seen in FIG. 5B, following the determination that User A won the community game (and, in certain instances, upon a determination that User A has not selected an avatar to represent them in the community game), the system removes (or alternatively mutes) the audio/video content of the other participants in the community game and enables User A fifteen seconds to celebrate. In certain embodiments, the system displays a clock or timer to indicate when the celebration time will conclude. In certain embodiments, rather than removing (or muting) the audio/video content of the other users, the system modifies such audio/video content such as reducing the volume setting for the other participants so that the volume setting for the winning user is the loudest. In certain embodiments, if the winning user has selected an avatar to represent them in the community game, the system enables the winning user to choose a reaction (or set of reactions) that their avatar can perform to celebrate their win during the amount of time of the live stream dedicated to the winning user's celebration.

In certain embodiments in which the system enables interactions while users wait in the lobby and/or during the play of the community game, the system maintains such interactions to between the interacting parties without broadcasting such interactions to other participants in the community game and/or users of client devices. In certain embodiments in which the system enables interactions while users wait in the lobby and/or during the play of the community game, the system maintains such interactions to between the participants in the community game without broadcasting such interactions to users of client devices. In certain embodiments in which the system enables interactions while users wait in the lobby and/or during the play of the community game, the system broadcasts such interactions to users of client devices. In these different embodiments, given the quantity of users that potentially have audio/video content of themselves captured at the same time, the system curates the audio/video content. In one such embodiment, when a particular user is speaking, the system only utilizes the captured audio/video content of that user (while, in certain instances, muting the other users and/or removing any video of such other users). In another such embodiment, when a particular user is speaking, the system increases the scale of the video of that user and/or highlights the video content of that particular user to bring focus to that user. In another embodiment, the system enables the participants in the community game to curate certain audio/video content, such as by voting for a particular user to be muted or have their video removed from the display.

In certain embodiments, the live streaming platform enables one or more viewers to place a back bet on the community game. In certain embodiments which enable betting to be placed on one or more aspects of the community game from one or more client devices, such a back bet on the community game, such wagers may be on any of any wagerable aspect of the community game, such as, but not limited to, who will become a participant in the community game, how many participants will be picked, and/or an individual participant's performance during the community game (i.e., back betting both for and against an individual participant).

In certain embodiments, the system enables any user of any client device the opportunity to place a back bet on the community game. In certain embodiments, the system enables certain users of client devices the opportunity to place a back bet on the community game. For example, the system limits the opportunity to place back bets to users of client devices that are on a list of friends with a participant in the community game. In certain embodiments, the opportunity of a user of a client device to place a back bet is based on one or more preferences of that user. For example, if a user of a client device is playing a particular game theme and a community game for that particular game theme is triggered independent of the user of the client device, the system enables the user of the client device to place a back bet on that community game (and/or join that community game). In certain embodiments, the opportunity of a user of a client device to place a back bet is based on the user selected to participate in the community game. For example, as seen in FIG. 5C, following the determining that User B was selected to participate in another community game, the system prompts users of client devices the opportunity to place a back bet for/against how User B (or any other selected user or group of selected users) does in the community game.

In certain embodiments which enable betting to be placed on one or more aspects of the community game from one or more client devices, following the placement of such wagers, the community game host reports data regarding the play of the community game to the live streaming platform which resolves such back bets placed as described above with relation to resolving back bets placed on plays of games occurring at a streaming device. As such, following the placement of a back bet associated with the community game, the live streaming platform withdraws funds from an account associated with the user of the client device to pay for the back bet placed. Following a determination that the back bet placed was a winning back bet, the live streaming platform deposits fund to the account associated with the user of the client device based on awards won from such back bets placed.

In certain embodiments, in addition to periodically triggering a play of a community game, the system determines if a community game termination event occurs in association with a currently ongoing community game. In these embodiments, the system monitors zero, one or more events and/or activities and utilizes such events and/or activities to determine whether or not a community game termination event occurs.

In certain embodiments, a community game termination event occurs based on one or more outcomes achieved (or lack thereof) in association with the community game. In certain embodiments, a community game termination event occurs based on an amount of time which the community game has been ongoing. In certain embodiments, a community game termination event occurs based on an amount wagered (or lack thereof) in association with the community game. In certain embodiments, a community game termination event occurs based on an amount won (or lack thereof) in association with the community game. In certain embodiments, a community game termination event occurs based on one or more interactions of users of client devices (e.g., viewers can vote to decide whether to continue or discontinue a community game). In certain embodiments, a community game termination event occurs based on a lack of interactions of users of client devices (e.g., a lack of viewer engagement causes the occurrence of the community game termination event). In certain embodiments, a community game termination event occurs based on one or more inputs by one or more participants in the community game (e.g., a user decides they no longer want to have their content streamed in association with the community game). In certain embodiments, a community game termination event occurs based on one or more inputs by a regulator to terminate the community game. In certain embodiments, a community game termination event occurs based on one or more inputs by an operator to terminate the community game.

In certain embodiments, a community game termination event occurs based on an interruption event, such as a malfunction. In certain embodiments, a community game termination event occurs based on a regulatory event, such as a handpay lockup event, at a device operating as the streaming device for part of the community game. In certain embodiments, a community game termination event occurs based on one or more displayed events occurring in association with the play of the game of the community game. In certain embodiments, the community game termination event occurs independent of any displayed events occurring in association with the play of the community game.

In certain embodiments, following the occurrence of the community game termination event, the system switches to another community game lobby of users selected to participate in another community game. In certain embodiments, following the occurrence of the community game termination event, the system switches to another play of another community game. In certain other embodiments, following the occurrence of the community game termination event, the system switches to a feed of a streaming device currently engaged in a streaming session.

In different embodiments, a community game triggering event, a community game participant selection event, and/or community game termination event occurs based on an outcome associated with one or more plays of any primary games or any secondary games. In one embodiment, such determinations are symbol driven based on the generation of one or more designated symbols or symbol combinations. In various embodiments, a generation of a designated symbol (or sub-symbol) or a designated set of symbols (or sub-symbols) over one or more plays of a primary game (and/or a secondary game) causes such conditions to be satisfied and/or one or more of such events to occur.

In different embodiments, the system does not provide any apparent reasons to the users for an occurrence of a community game triggering event, a community game participant selection event, and/or community game termination event. In these embodiments, such determinations are not triggered by an event in a primary game or based specifically on any of the plays of any primary games or any secondary games. That is, these events occur without any explanation or alternatively with simple explanations.

In one such embodiment, a community game triggering event, a community game participant selection event, and/or community game termination event occurs based on an amount of coin-in. In this embodiment, the system determines if an amount of coin-in reaches or exceeds a designated amount of coin-in (i.e., a threshold coin-in amount). Upon the amount of coin-in wagered reaching or exceeding the threshold coin-in amount, the system causes one or more of such events or conditions to occur. In another such embodiment, a community game triggering event, a community game participant selection event, and/or community game termination event occurs based on an amount of virtual currency-in. In this embodiment, the system determines if an amount of virtual currency-in wagered reaches or exceeds a designated amount of virtual currency-in (i.e., a threshold virtual currency-in amount). Upon the amount of virtual currency-in wagered reaching or exceeding the threshold virtual currency-in amount, the system causes one or more of such events or conditions to occur. In different embodiments, the threshold coin-in amount and/or the threshold virtual currency-in amount is predetermined, randomly determined, determined based on a user's status (such as determined through a player tracking system), determined based on a generated symbol or symbol combination, determined based on a random determination by the live streaming platform server or a separate component operating with the live streaming platform server, determined based on a random determination, determined based on one or more side wagers placed, determined based on the user's primary game wager, determined based on time (such as the time of day) or determined based on any other suitable method or criteria.

In one such embodiment, a community game triggering event, a community game participant selection event, and/or community game termination event occurs based on an amount of coin-out. In this embodiment, the system determines if an amount of coin-out reaches or exceeds a designated amount of coin-out (i.e., a threshold coin-out amount). Upon the amount of coin-out reaching or exceeding the threshold coin-out amount, the system causes one or more of such events or conditions to occur. In another such embodiment, a community game triggering event, a community game participant selection event, and/or community game termination event occurs based on an amount of virtual currency-out. In this embodiment, the system determines if an amount of virtual currency-out reaches or exceeds a designated amount of virtual currency-out (i.e., a threshold virtual currency-out amount). Upon the amount of virtual currency-out reaching or exceeding the threshold virtual currency-out amount, the system causes one or more of such events or conditions to occur. In different embodiments, the threshold coin-out amount and/or the threshold virtual currency-out amount is predetermined, randomly determined, determined based on a user's status (such as determined through a player tracking system), determined based on a generated symbol or symbol combination, determined based on a random determination by the live streaming platform server or a separate component operating with the live streaming platform server, determined based on a random determination, determined based on one or more side wagers placed, determined based on the user's primary game wager, determined based on time (such as the time of day) or determined based on any other suitable method or criteria.

In different embodiments, a community game triggering event, a community game participant selection event, and/or community game termination event occurs based on a predefined variable reaching a defined parameter threshold. For example, when the 1000^{th} user has placed a back bet in association with a streaming session of a user of a streaming device (ascertained from a player tracking system), one or more of such events or conditions occur. In different embodiments, the predefined parameter thresholds include a length of time, a length of time after a certain dollar amount is hit, a wager level threshold for a specific device, a number of gaming devices active, or any other parameter that defines a suitable threshold.

In different embodiments, a community game triggering event, a community game participant selection event, and/or community game termination event occurs based on a quantity of games played. In this embodiment, a quantity of games played is set for when one or more of such events or conditions will occur. In one embodiment, such a set quantity of games played is based on historic data.

In different embodiments, a community game triggering event, a community game participant selection event, and/or community game termination event occurs based on time. In this embodiment, a time is set for when one or more of such events or conditions will occur. In one embodiment, such a set time is based on historic data.

In different embodiments, a community game triggering event, a community game participant selection event, and/or community game termination event occurs based upon operator defined user eligibility parameters stored on a player tracking system (such as via a player tracking card or other suitable manner). In this embodiment, the parameters for eligibility are defined by the system operator based on any suitable criterion. In one embodiment, the system recognizes the user's identification (via the player tracking system). The system determines the player tracking level of the user and if the current player tracking level defined by the operator is eligible for one or more of such events or conditions. In one embodiment, the operator defines minimum bet levels required for such events or conditions to occur based on the user's level.

In different embodiments, a community game triggering event, a community game participant selection event, and/or community game termination event occurs based on a system determination, including one or more random selections by the live streaming platform server or a separate component operating with the live streaming platform server. For example, the system tracks all active devices associated with a streaming session and the wagers they placed, wherein based on the device's state as well as one or more wager pools associated with the devices, the system determines whether to one or more of such events or conditions will occur. In one such embodiment, the user who consistently places a higher wager is more likely to be associated with an occurrence of one or more of such events or conditions than a user who consistently places a minimum wager. It should be appreciated that the criteria for determining whether a user is in active status or inactive status for determining if one or more of such events occur may the same as, substantially the same as, or different than the criteria for determining whether a user is in active status or inactive status for another one of such events to occur.

In different embodiments, a community game triggering event, a community game participant selection event, and/or community game termination event occurs based on a determination of if any numbers allotted to a device match a randomly selected number. In this embodiment, upon or prior to each play, the system selects a random number from a range of numbers and during each primary game, the system allocates the first N numbers in the range, where N is the number of credits bet by the user in that primary game. At the end of the primary game, the randomly selected number is compared with the numbers allocated to the user and if a match occurs, one or more of such events or conditions occur.

Accordingly, in certain embodiments, the system of the present disclosure enables different devices to operate as a streaming device prior to a multiple participant event (e.g., to capture interactions between users selected to participate in the multiple participant event), during the multiple participant event (e.g., to capture community game content and/or interactions between participants of the multiple participant event) and/or after the multiple participant event (e.g., to capture participant reactions to the multiple participant event). By dynamically configuring streamed content from different devices in association with different portions of a multiple participant event, the system benefits both users of these devices (in respect to enabling such users to operate as a streamer for at least part of a multiple participant event) and users of other devices (in respect to offering such users a more diverse source of content). As such, employing multiple devices to operate, simultaneously or sequentially, as a streaming device for different parts of a multiple participant event represents an operational change that overcomes the technical challenges (e.g., in quantity of participants that may join and in remote locations of participants) presented with how multiple participant events, such as community games, are currently employed at gaming establishments.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “streaming device” and/or “client device” as used herein refers to various configurations of: (a) one or more servers; (b) one or more electronic gaming machines; (c) one or more components of a gaming establishment management system associated with an electronic gaming machine, such as a slot machine interface board; (d) one or more devices associated with an electronic gaming machine, such as a slot machine interface board, operating independent of any components of a gaming establishment management system, and/or (e) one or more personal gaming devices (e.g., desktop computers, laptop computers, tablet computers or computing devices, personal digital assistants, mobile phones, and other mobile computing devices). Thus, in various embodiments, the streaming devices and client devices of the present disclosure include: (a) one or more electronic gaming machines in combination with one or more servers; (b) one or more slot machine interface boards (or other components of a gaming establishment management system or other components independent of a gaming establishment management system) in communication with one or more servers; (c) one or more personal gaming devices in combination with one or more servers; (d) one or more personal gaming devices in combination with one or more electronic gaming machines; (e) one or more personal gaming devices in combination with one or more slot machine interface boards (or other components of a gaming establishment management system or other components independent of a gaming establishment management system); (f) one or more personal gaming devices, one or more electronic gaming machines, one or more slot machine interface boards (or other components of a gaming establishment management system or other components independent of a gaming establishment management system) and one or more servers in combination with one another; (g) a single electronic gaming machine; (h) a plurality of electronic gaming machines in combination with one another; (i) a single personal gaming device; (j) a plurality of personal gaming devices in combination with one another; (k) as single slot machine interface board (or another component of a gaming establishment management system or another component independent of a gaming establishment management system); (l) a plurality of slot machine interface boards (or other components of a gaming establishment management system or other components independent of a gaming establishment management system) in combination with one another; (m) a single server; and/or (n) a plurality of servers in combination with one another. For brevity and clarity and unless specifically stated otherwise, “streaming device as used herein represents one streaming device or a plurality of streaming devices, “client device” as used herein represents one client device or a plurality of client devices and “server” as used herein represents one server or a plurality of servers.

As noted above, in various embodiments, the system includes a streaming device and/or a client device in combination with a server, such as a live streaming platform server or a separate component operating with the live streaming platform server. In such embodiments, the streaming device and/or client device is configured to communicate with the server through a data network or remote communication link. In certain such embodiments, the streaming device and/or client device is configured to communicate with another streaming device and/or client device through the same data network or remote communication link or through a different data network or remote communication link.

In certain embodiments in which the system includes a streaming device and/or a client device in combination with a server, the server is any suitable computing device (such as a server) that includes at least one processor and at least one memory device or data storage device. As further described herein, the streaming device and/or client device includes at least one streaming device and/or client device processor configured to transmit and receive data or signals representing events, messages, commands, or any other suitable information between the streaming device and/or client device and the server. The at least one processor of that streaming device and/or client device is configured to execute the events, messages, or commands represented by such data or signals in conjunction with the operation of the streaming device and/or client device. Moreover, the at least one processor of the server is configured to transmit and receive data or signals representing events, messages, commands, or any other suitable information between the server and the streaming device and/or client device. The at least one processor of the server is configured to execute the events, messages, or commands represented by such data or signals in conjunction with the operation of the server. One, more than one, or each of the functions of the server may be performed by the at least one processor of the streaming device and/or client device. Further, one, more than one, or each of the functions of the at least one processor of the streaming device and/or client device may be performed by the at least one processor of the server.

In certain such embodiments, computerized instructions for controlling any games (such as any primary or base games and/or any secondary or bonus games) displayed by the streaming device and/or client device are executed by the server. In such “thin client” embodiments, the server remotely controls any games (or other suitable interfaces) displayed by the streaming device and/or client device, and the streaming device and/or client device is utilized to display such games (or suitable interfaces) and to receive one or more inputs or commands. In other such embodiments, computerized instructions for controlling any games displayed by the streaming device and/or client device are communicated from the server to the streaming device and/or client device and are stored in at least one memory device of the streaming device and/or client device. In such “thick client” embodiments, the at least one processor of the streaming device and/or client device executes the computerized instructions to control any games (or other suitable interfaces) displayed by the streaming device and/or client device.

In various embodiments in which the system includes a plurality of streaming devices and/or client devices, one or more of the streaming devices and/or client devices are thin client streaming devices and/or client devices and one or more of the streaming devices and/or client devices are thick client streaming devices and/or client devices. In other embodiments in which the system includes one or more streaming devices and/or client devices, certain functions of one or more of the streaming devices and/or client devices are implemented in a thin client environment, and certain other functions of one or more of the streaming devices and/or client devices are implemented in a thick client environment. In one such embodiment in which the system includes a streaming device and/or a client device and a server, computerized instructions for controlling any primary or base games displayed by the streaming device and/or client device are communicated from the server to the streaming device and/or client device in a thick client configuration, and computerized instructions for controlling any secondary or bonus games or other functions displayed by the streaming device and/or client device are executed by the server in a thin client configuration.

In certain embodiments in which the system includes: (a) a streaming device and/or a client device configured to communicate with a server through a data network; and/or (b) a plurality of streaming devices and/or client devices configured to communicate with one another through a data network, the data network is a local area network (LAN) in which the streaming devices and/or client devices are located substantially proximate to one another and/or the server. In one example, the streaming devices and/or client devices and the server are located in a gaming establishment or a portion of a gaming establishment. In other embodiments in which the system includes: (a) a streaming device and/or a client device configured to communicate with a server through a data network; and/or (b) a plurality of streaming devices and/or client devices configured to communicate with one another through a data network, the data network is a wide area network (WAN) in which one or more of the streaming devices and/or client devices are not necessarily located substantially proximate to another one of the streaming devices and/or client devices and/or the server. For example, one or more of the streaming devices and/or client devices are located: (a) in an area of a gaming establishment different from an area of the gaming establishment in which the server is located; or (b) in a gaming establishment different from the gaming establishment in which the server is located. In another example, the server is not located within a gaming establishment in which the streaming devices and/or client devices are located. In certain embodiments in which the data network is a WAN, the system includes a server and a streaming device and/or a client device each located in a different gaming establishment in a same geographic area, such as a same city or a same state. Systems in which the data network is a WAN are substantially identical to systems in which the data network is a LAN, though the quantity of streaming devices and/or client devices in such systems may vary relative to one another.

In further embodiments in which the system includes: (a) a streaming device and/or a client device configured to communicate with a server through a data network; and/or (b) a plurality of streaming devices and/or client devices configured to communicate with one another through a data network, the data network is an internet or an intranet. In certain such embodiments, an internet browser of the streaming device and/or client device is usable to access an internet game page from any location where an internet connection is available. In one such embodiment, after the streaming device and/or client device accesses the internet game page, the server identifies a user before enabling that user to place any wagers on any plays of any wagering games. In one example, the server identifies the user by requiring a user account of the user to be logged into via an input of a unique username and password combination assigned to the user. The server may, however, identify the user in any other suitable manner, such as by validating a player tracking identification number associated with the user; by reading a player tracking card or other smart card inserted into a card reader (as described below); by validating a unique user identification number associated with the user by the server; or by identifying the streaming device and/or client device, such as by identifying the MAC address or the IP address of the internet facilitator. In various embodiments, once the server identifies the user, the server enables placement of one or more wagers on one or more plays of one or more primary or base games and/or one or more secondary or bonus games, and displays those plays via the internet browser of the streaming device and/or client device.

The server and the streaming device and/or client device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium.

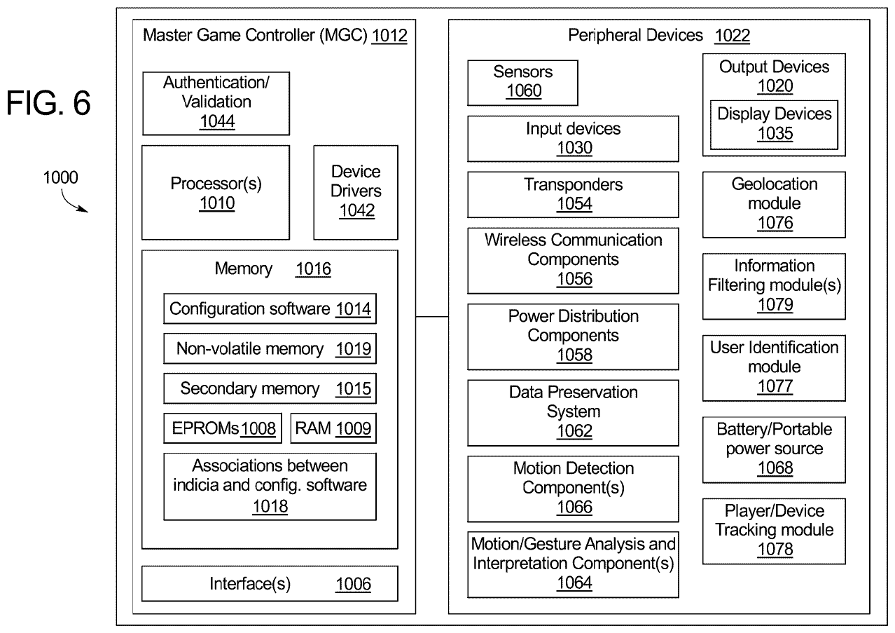

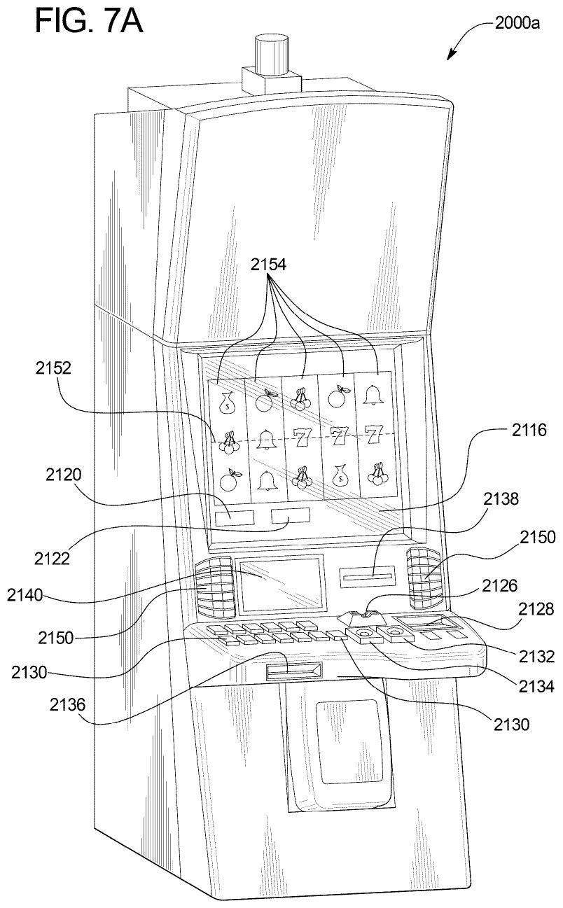

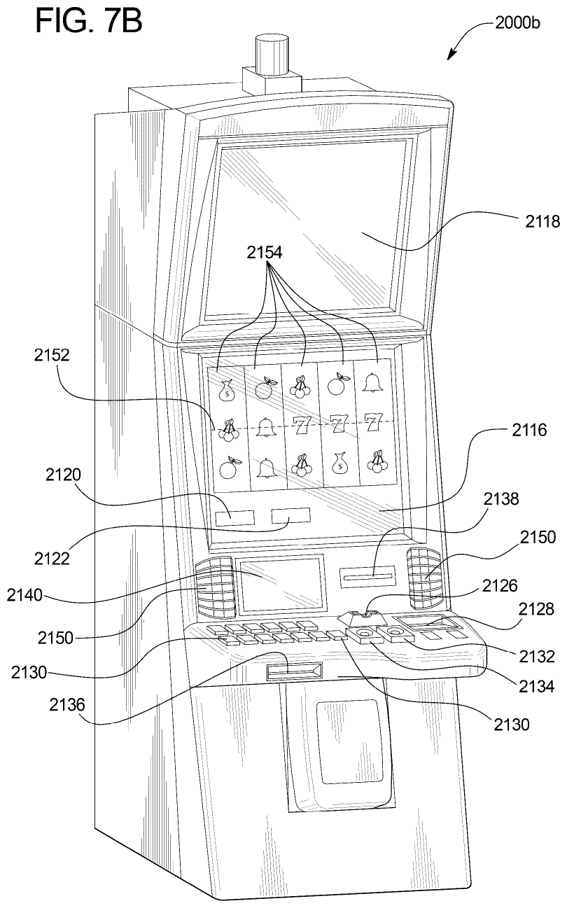

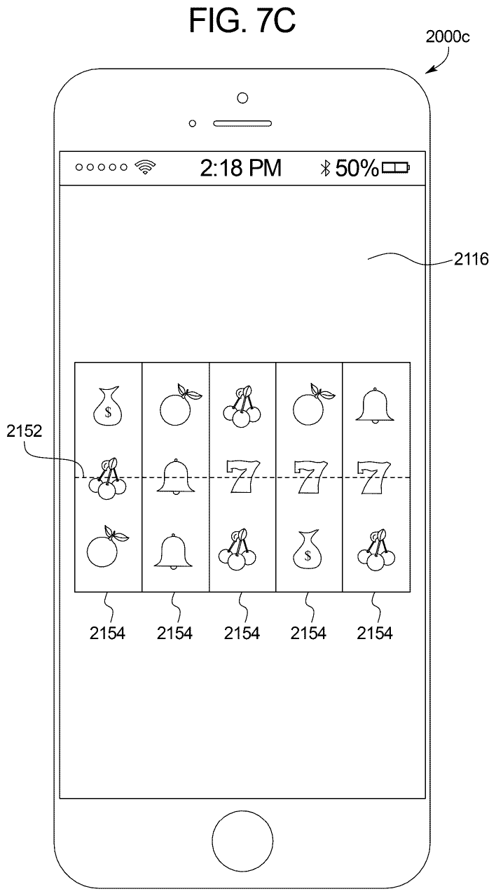

FIG. 6 is a block diagram of an example streaming device and/or client device 1000 and FIGS. 7A and 7B include two different example streaming devices and/or client devices 2000a and 2000b. The streaming devices and/or client devices 1000, 2000a, and 2000b are merely example streaming devices and/or client devices, and different streaming devices and/or client devices may be implemented using different combinations of the components shown in the streaming devices and/or the client devices 1000, 2000a, and 2000b. Although the below refers to streaming devices and/or client devices, in various embodiments personal gaming devices (such as personal gaming device 2000c of FIG. 7C) may include some or all of the below components.

In these embodiments, the streaming device and/or the client device 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the streaming device and/or the client device; (3) accessing memory to configure or reconfigure game parameters in the memory according to indicia read from the streaming device and/or the client device; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the streaming device and/or the client device (described below), while in other embodiments at least one component of the master gaming controller 1012 resides outside of the housing of the streaming device and/or the client device.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the streaming device and/or the client device of the present disclosure. In certain embodiments, the at least one memory device 1016 resides within the housing of the streaming device and/or the client device (described below), while in other embodiments at least one component of the at least one memory device 1016 resides outside of the housing of the streaming device and/or the client device.

The at least one memory device 1016 is configured to store, for example: (1) configuration software 1014, such as all the parameters and settings for a game playable on the streaming device and/or the client device; (2) associations 1018 between configuration indicia read from a streaming device and/or a client device with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the streaming device and/or the client device to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the streaming device and/or the client device to control the streaming device and/or the client device. The at least one memory device 1016 of the streaming device and/or the client device also stores other operating data, such as image data, event data, input data, random number generators (RNGs) or pseudo-RNGs, paytable data or information, and/or applicable game rules that relate to the play of one or more games on the streaming device and/or the client device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a user uses such a removable memory device in a streaming device and/or a client device to implement at least part of the present disclosure. In other embodiments, part or all of the program code and/or the operating data is downloaded to the at least one memory device of the streaming device and/or the client device through any suitable data network described above (such as an internet or intranet).

The at least one memory device 1016 also stores a plurality of device drivers 1042. Examples of different types of device drivers include device drivers for streaming device and/or client device components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the streaming device and/or the client device. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the streaming device and/or the client device loads the new device driver from the at least one memory device to enable communication with the new device. For instance, one type of card reader in the streaming device and/or the client device can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified streaming device and/or client device components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one user/device tracking module 1078; and (14) at least one information filtering module 1079.

The at least one output device 1020 includes at least one display device 1035 configured to display any game(s) displayed by the streaming device and/or the client device and any suitable information associated with such game(s). In certain embodiments, the display devices are connected to or mounted on a housing of the streaming device and/or the client device (described below). In various embodiments, the display devices serve as digital glass configured to advertise certain games or other aspects of the gaming establishment in which the streaming device and/or the client device is located. In various embodiments, the streaming device and/or the client device includes one or more of the following display devices: (a) a central display device; (b) a player tracking display configured to display various information regarding a user's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example streaming device and/or client device 2000a illustrated in FIG. 7A includes a central display device 2116, a player tracking display 2140, a credit display 2120, and a bet display 2122. The example streaming device and/or client device 2000b illustrated in FIG. 7B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the streaming device and/or the client device are configured to display one or more game and/or non-game images, symbols, and indicia. In certain embodiments, the display devices of the streaming device and/or the client device are configured to display any suitable visual representation or exhibition of the movement of objects; dynamic lighting; video images; images of people, characters, places, things, and faces of cards; and the like. In certain embodiments, the display devices of the streaming device and/or the client device are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the streaming device and/or the client device receives an actuation of a cashout device (described below), the streaming device and/or the client device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example streaming devices and/or client devices 2000a and 2000b illustrated in FIGS. 7A and 7B each include a ticket printer and dispenser 2136.

In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user. While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the streaming device and/or the client device, such as an attract mode. The example streaming devices and/or client devices 2000a and 2000b illustrated in FIGS. 7A and 7B each include a plurality of speakers 2150. In another such embodiment, the streaming device and/or the client device provides dynamic sounds coupled with attractive multimedia images displayed on one or more of the display devices to provide an audio-visual representation or to otherwise display full-motion video with sound to attract users to the streaming device and/or the client device. In certain embodiments, the streaming device and/or the client device displays a sequence of audio and/or visual attraction messages during idle periods to attract potential users to the streaming device and/or the client device. The videos may be customized to provide any appropriate information.

The at least one input device 1030 may include any suitable device that enables an input signal to be produced and received by the at least one processor 1010 of the streaming device and/or the client device.

In one embodiment, the at least one input device 1030 includes a payment device configured to communicate with the at least one processor of the streaming device and/or the client device to fund the streaming device and/or the client device. In certain embodiments, the payment device includes one or more of: (a) a bill acceptor into which paper money is inserted to fund the streaming device and/or the client device; (b) a ticket acceptor into which a ticket or a voucher is inserted to fund the streaming device and/or the client device; (c) a coin slot into which coins or tokens are inserted to fund the streaming device and/or the client device; (d) a reader or a validator for credit cards, debit cards, or credit slips into which a credit card, debit card, or credit slip is inserted to fund the streaming device and/or the client device; (e) a user identification card reader into which a user identification card is inserted to fund the streaming device and/or the client device; or (f) any suitable combination thereof. The example streaming devices and/or client devices 2000a and 2000b illustrated in FIGS. 7A and 7B each include a combined bill and ticket acceptor 2128 and a coin slot 2126.

In one embodiment, the at least one input device 1030 includes a payment device configured to enable the streaming device and/or the client device to be funded via an electronic funds transfer, such as a transfer of funds from a bank account. In another embodiment, the streaming device and/or the client device includes a payment device configured to communicate with a mobile device of a user, such as a mobile phone, a radio frequency identification tag, or any other suitable wired or wireless device, to retrieve relevant information associated with that user to fund the streaming device and/or the client device. When the streaming device and/or the client device is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the streaming device and/or the client device (such as a hard key or a programmable soft key), or (2) an icon displayed on a display device of the streaming device and/or the client device (described below) that is actuatable via a touch screen of the streaming device and/or the client device (described below) or via use of a suitable input device of the streaming device and/or the client device (such as a mouse or a joystick). One such wagering or betting device is as a maximum wager or bet device that, when actuated, causes the streaming device and/or the client device to place a maximum wager on a play of a game. Another such wagering or betting device is a repeat bet device that, when actuated, causes the streaming device and/or the client device to place a wager that is equal to the previously-placed wager on a play of a game. A further such wagering or betting device is a bet one device that, when actuated, causes the streaming device and/or the client device to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the streaming device and/or the client device (such as a hard key or a programmable soft key), or (2) an icon displayed on a display device of the streaming device and/or the client device (described below) that is actuatable via a touch screen of the streaming device and/or the client device (described below) or via use of a suitable input device of the streaming device and/or the client device (such as a mouse or a joystick). After a user appropriately funds the streaming device and/or the client device and places a wager, the streaming device and/or the client device activates the game play activation device to enable the user to actuate the game play activation device to initiate a play of a game on the streaming device and/or the client device (or another suitable sequence of events associated with the streaming device and/or the client device). After the streaming device and/or the client device receives an actuation of the game play activation device, the streaming device and/or the client device initiates the play of the game. The example streaming devices and/or client devices 2000a and 2000b illustrated in FIGS. 7A and 7B each include a game play activation device in the form of a game play initiation button 2132. In other embodiments, the streaming device and/or the client device begins game play automatically upon appropriate funding rather than upon utilization of the game play activation device.

In other embodiments, the at least one input device 1030 includes a cashout device. In various embodiments, the cashout device is: (1) a mechanical button supported by the housing of the streaming device and/or the client device (such as a hard key or a programmable soft key), or (2) an icon displayed on a display device of the streaming device and/or the client device (described below) that is actuatable via a touch screen of the streaming device and/or the client device (described below) or via use of a suitable input device of the streaming device and/or the client device (such as a mouse or a joystick). When the streaming device and/or the client device receives an actuation of the cashout device from a user and the user has a positive (i.e., greater-than-zero) credit balance, the streaming device and/or the client device initiates a payout associated with the user's credit balance. The example streaming devices and/or client devices 2000a and 2000b illustrated in FIGS. 7A and 7B each include a cashout device in the form of a cashout button 2134.

In various embodiments, the at least one input device 1030 includes a plurality of buttons that are programmable by the streaming device and/or the client device operator to, when actuated, cause the streaming device and/or the client device to perform particular functions. For instance, such buttons may be hard keys, programmable soft keys, or icons icon displayed on a display device of the streaming device and/or the client device (described below) that are actuatable via a touch screen of the streaming device and/or the client device (described below) or via use of a suitable input device of the streaming device and/or the client device (such as a mouse or a joystick). The example streaming devices and/or client devices 2000a and 2000b illustrated in FIGS. 7A and 7B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the streaming device and/or the client device by touching the touch screen at the appropriate locations.

In embodiments including a player tracking system, as further described below, the at least one input device 1030 includes a card reader in communication with the at least one processor of the streaming device and/or the client device. The example streaming devices and/or client devices 2000a and 2000b illustrated in FIGS. 7A and 7B each include a card reader 2138. The card reader is configured to read a user identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the streaming device and/or the client device. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the streaming device and/or the client device, such as one or more rechargeable power sources (e.g., rechargeable batteries) located at the streaming device and/or the client device.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the streaming device and/or the client device; detecting the presence and/or identity of various persons (e.g., users, casino employees, etc.), devices (e.g., user input devices), and/or systems within a predetermined proximity to the streaming device and/or the client device.

The at least one data preservation component 1062 is configured to detect or sense one or more events and/or conditions that, for example, may result in damage to the streaming device and/or the client device and/or that may result in loss of information associated with the streaming device and/or the client device. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected user movements and/or gestures to determine appropriate user input information relating to the detected user movements and/or gestures. For example, in one embodiment, the at least one motion/gesture analysis and interpretation component 1064 is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source 1068 enables the streaming device and/or the client device to operate in a mobile environment. For example, in one embodiment, the streaming device and/or the client device includes one or more rechargeable batteries.

The at least one geolocation module 1076 is configured to acquire geolocation information from one or more remote sources and use the acquired geolocation information to determine information relating to a relative and/or absolute position of the streaming device and/or the client device. For example, in one implementation, the at least one geolocation module 1076 is configured to receive GPS signal information for use in determining the position or location of the streaming device and/or the client device. In another implementation, the at least one geolocation module 1076 is configured to receive multiple wireless signals from multiple remote devices (e.g., streaming devices and/or client devices, servers, wireless access points, etc.) and use the signal information to compute position/location information relating to the position or location of the streaming device and/or the client device.

The at least one user identification module 1077 is configured to determine the identity of the current user or current owner of the streaming device and/or the client device. For example, in one embodiment, the current user is required to perform a login process at the streaming device and/or the client device in order to access one or more features. Alternatively, the streaming device and/or the client device is configured to automatically determine the identity of the current user based on one or more external signals, such as an RFID tag or badge worn by the current user and that provides a wireless signal to the streaming device and/or the client device that is used to determine the identity of the current user. In at least one embodiment, various security features are incorporated into the streaming device and/or the client device to prevent unauthorized users from accessing confidential or sensitive information.

The at least one information filtering module 1079 is configured to perform filtering (e.g., based on specified criteria) of selected information to be displayed at one or more displays 1035 of the streaming device and/or the client device.

In various embodiments, the streaming device and/or the client device includes a plurality of communication ports configured to enable the at least one processor of the streaming device and/or the client device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example streaming devices and/or client devices 2000a and 2000b illustrated in FIGS. 7A and 7B, the streaming device and/or the client device has a support structure, housing, or cabinet that provides support for a plurality of the input devices and the output devices of the streaming device and/or the client device. Further, the streaming device and/or the client device is configured such that a user may operate it while standing or sitting. In various embodiments, the streaming device and/or the client device is positioned on a base or stand, or is configured as a pub-style tabletop game (not shown) that a user may operate typically while sitting. As illustrated by the different example streaming devices and/or client devices 2000a and 2000b shown in FIGS. 7A and 7B, streaming devices and/or client devices may have varying housing and display configurations.

In certain embodiments, the streaming device and/or the client device is a device that has obtained approval from a regulatory gaming commission, and in other embodiments, the streaming device and/or the client device is a device that has not obtained approval from a regulatory gaming commission.

The streaming devices and/or client devices described above are merely three examples of different types of streaming devices and/or client devices. Certain of these example streaming devices and/or client devices may include one or more elements that may not be included in all systems, and these example streaming devices and/or client devices may not include one or more elements that are included in other systems. For example, certain streaming devices and/or client devices include a coin acceptor while others do not.

In various embodiments, a streaming device and/or a client device may be implemented in one of a variety of different configurations. In various embodiments, the streaming device and/or the client device may be implemented as one of: (a) a dedicated streaming device and/or client device in which computerized game programs executable by the streaming device and/or the client device for controlling any primary or base games (referred to herein as “primary games”) and/or any secondary or bonus games or other functions (referred to herein as “secondary games”) displayed by the streaming device and/or the client device are provided with the streaming device and/or the client device before delivery to a gaming establishment or before being provided to a user; and (b) a changeable streaming device and/or client device in which computerized game programs executable by the streaming device and/or the client device for controlling any primary games and/or secondary games displayed by the streaming device and/or the client device are downloadable or otherwise transferred to the streaming device and/or the client device through a data network or remote communication link; from a USB drive, flash memory card, or other suitable memory device; or in any other suitable manner after the streaming device and/or the client device is physically located in a gaming establishment or after the streaming device and/or the client device is provided to a user.

As generally explained above, in various embodiments in which the system includes a server and a changeable streaming device and/or client device, the at least one memory device of the server stores different game programs and instructions executable by the at least one processor of the changeable streaming device and/or client device to control one or more primary games and/or secondary games displayed by the changeable streaming device and/or client device. More specifically, each such executable game program represents a different game or a different type of game that the at least one changeable streaming device and/or client device is configured to operate. In one example, certain of the game programs are executable by the changeable streaming device and/or client device to operate games having the same or substantially the same game play but different paytables. In different embodiments, each executable game program is associated with a primary game, a secondary game, or both. In certain embodiments, an executable game program is executable by the at least one processor of the at least one changeable streaming device and/or client device as a secondary game to be played simultaneously with a play of a primary game (which may be downloaded to or otherwise stored on the at least one changeable streaming device and/or client device), or vice versa.

In operation of such embodiments, the server is configured to communicate one or more of the stored executable game programs to the at least one processor of the changeable streaming device and/or client device. In different embodiments, a stored executable game program is communicated or delivered to the at least one processor of the changeable streaming device and/or client device by: (a) embedding the executable game program in a device or a component (such as a microchip to be inserted into the changeable streaming device and/or client device); (b) writing the executable game program onto a disc or other media; or (c) uploading or streaming the executable game program over a data network (such as a dedicated data network). After the executable game program is communicated from the server to the changeable streaming device and/or client device, the at least one processor of the changeable streaming device and/or client device executes the executable game program to enable the primary game and/or the secondary game associated with that executable game program to be played using the display device(s) and/or the input device(s) of the changeable streaming device and/or client device. That is, when an executable game program is communicated to the at least one processor of the changeable streaming device and/or client device, the at least one processor of the changeable streaming device and/or client device changes the game or the type of game that may be played using the changeable streaming device and/or client device.

In certain embodiments, the system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the system includes a server and a streaming device and/or a client device, the streaming device and/or the client device is configured to communicate with the server for monitoring purposes only. In such embodiments, the streaming device and/or the client device determines the game outcome(s) and/or award(s) to be provided in any of the manners described above, and the server monitors the activities and events occurring on the streaming device and/or the client device. In one such embodiment, the system includes a real-time or online accounting and gaming information system configured to communicate with the server. In this embodiment, the accounting and gaming information system includes: (a) a user database configured to store user profiles, (b) a player tracking module configured to track users (as described below), and (c) a credit system configured to provide automated transactions.

As noted above, in various embodiments, the system includes one or more executable game programs executable by at least one processor of the system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example streaming device and/or client device 2000b shown in FIG. 7B includes a payline 2152 and a plurality of reels 2154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement. In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided. In various embodiments, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of user excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game. In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game. In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game. In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of streaming devices and/or client devices, the streaming devices and/or the client devices are configured to communicate with one another to provide a group gaming environment. In certain such embodiments, the streaming devices and/or the client devices enable users of those streaming devices and/or client devices to work in conjunction with one another, such as by enabling the users to play together as a team or group, to win one or more awards. In other such embodiments, the streaming devices and/or the client devices enable users of those streaming devices and/or client devices to compete against one another for one or more awards. In one such embodiment, the streaming devices and/or the client devices enable the users of those streaming devices and/or client devices to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a user's gaming activity. In one such embodiment, the player tracking system does so through the use of player tracking cards. In this embodiment, a user is issued a user identification card that has an encoded user identification number that uniquely identifies the user. When the user's playing tracking card is inserted into a card reader of the system to begin a gaming session, the card reader reads the user identification number off the player tracking card to identify the user. The system timely tracks any suitable information or data relating to the identified user's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more users, the player tracking system includes the user's account number, the user's card number, the user's first name, the user's surname, the user's preferred name, the user's player tracking ranking, any promotion status associated with the user's player tracking card, the user's address, the user's birthday, the user's anniversary, the user's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the user must first access a gaming website via an internet browser of the personal gaming device or execute an application (commonly called an “app”) installed on the personal gaming device before the user can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the user before enabling game play on the personal gaming device (or, in some embodiments, before enabling monetary wager-based game play on the personal gaming device). In these embodiments, the user must identify herself to the one or more servers, such as by inputting the user's unique username and password combination (or in any other manners described above.

Once identified, the one or more servers enable the user to establish an account balance from which the user can draw credits usable to wager on plays of a game. In certain embodiments, the one or more servers enable the user to initiate an electronic funds transfer to transfer funds from a bank account to the user's account balance. In other embodiments, the one or more servers enable the user to make a payment using the user's credit card, debit card, or other suitable device to add money to the user's account balance. In other embodiments, the one or more servers enable the user to add money to the user's account balance via a peer-to-peer type application, such as PayPal or Venmo. The one or more servers also enable the user to cash out the user's account balance (or part of it) in any suitable manner, such as via an electronic funds transfer or by initiating creation of a paper check that is mailed to the user.

In certain embodiments, the one or more servers include a payment server that handles establishing and cashing out users'account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the user's account balance can cover the desired wager (i.e., includes a monetary balance at least equal to the desired wager).

If the payment server determines that the user's account balance cannot cover the desired wager, the payment server notifies the game server, which then instructs the personal gaming device to display a suitable notification to the user that the user's account balance is too low to place the desired wager. If the payment server determines that the user's account balance can cover the desired wager, the payment server deducts the desired wager from the account balance and notifies the game server. The game server then determines an outcome and any associated award for the play of the game. The game server notifies the payment server of any nonzero award, and the payment server increases the user's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes a streaming device and/or a client device configured to communicate with a personal gaming device—such as a smartphone, a tablet computer, a desktop computer, or a laptop computer—to enable tethered mobile game play using the personal gaming device. Generally, in these embodiments, the streaming device and/or the client device establishes communication with the personal gaming device and enables the user to play games on the streaming device and/or the client device remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the internet) to integrate a user's gaming experience with the user's social networking account. This enables the system to send certain information to the social network server that the social network server can use to create content (such as text, an image, and/or a video) and post it to the user's wall, newsfeed, or similar area of the social networking website accessible by the user's connections (and in certain cases the public) such that the user's connections can view that information. This also enables the system to receive certain information from the social network server, such as the user's likes or dislikes or the user's list of connections. In certain embodiments, the system enables the user to link the user's user account to the user's social networking account(s). This enables the system to, once it identifies the user and initiates a gaming session (such as via the user logging in to a website (or an application) on the user's personal gaming device or via the user inserting the user's player tracking card into a streaming device and/or a client device), link that gaming session to the user's social networking account(s). In other embodiments, the system enables the user to link the user's social networking account(s) to individual gaming sessions when desired by providing the required login information.

For instance, in one embodiment, if a user wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the user's wall (or other suitable area) of the social networking website for the user's connections to see (and to entice them to play). In another embodiment, if a user joins a multiuser game and there is another seat available, the system sends that information to the social network sever to enable the server to create associated content (such as text indicating a vacancy for that particular game) and to post that content to the user's wall (or other suitable area) of the social networking website for the user's connections to see (and to entice them to fill the vacancy). In another embodiment, if the user consents, the system sends advertisement information or offer information to the social network server to enable the social network server to create associated content (such as text or an image reflecting an advertisement and/or an offer) and to post that content to the user's wall (or other suitable area) of the social networking website for the user's connections to see. In another embodiment, the system enables the user to recommend a game to the user's connections by posting a recommendation to the user's wall (or other suitable area) of the social networking website.

Certain of the devices or components of the present disclosure, such as streaming devices and/or client devices located in a casino or another gaming establishment, include certain components and/or are configured to operate in certain manners that differentiate these systems from general purpose computing devices.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the user, the EGM stores the pre-power failure state in a non-volatile memory, returns to that state upon restoration of power, and provides the award to the user. This requirement affects the software and hardware design on EGMs. General purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a user of an EGM from manipulating the EGM's hardware and software in a manner that gives him an unfair, and in some cases illegal, advantage.

A third difference between EGMs and general-purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the user's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a user is required to make a number of selections on a video display screen. When a malfunction has occurred after the user has made one or more selections, the EGM may be restored to a state that shows the graphical presentation just before the malfunction including an indication of selections that have already been made by the user. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a user may decide that in a previous game of chance that they did not receive credit for an award that they believed they won. The game history information may be used to reconstruct the state of the EGM before, during, and/or after the disputed game to demonstrate whether the user was correct or not in the user's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention claimed is:

1. A live streaming platform server comprising:
a processor; and
a memory device that stores a plurality of instructions that, when executed by the processor following an occurrence of a community game triggering event, an occurrence of a first community game participant selection event associated with a first user of a first device, and an occurrence of a second community game participant selection event associated with a second, different user of a second, different device, cause the processor to:
responsive to a receipt, from the first device, of data associated with first content captured of the first user, communicate, to a client device and at least partially based on the data associated with the first content, data associated with a first portion of a live stream, and
responsive to a receipt, from the second, different device, of data associated with second, different content captured of the second, different user, communicate, to the client device and at least partially based on the data associated with the second, different content, data associated with a second portion of the live stream.

2. The live streaming platform server of claim 1, wherein the first portion of the live stream and the second portion of the live stream occur at different points in time of the live stream.

3. The live streaming platform server of claim 1, wherein the first content captured of the first user comprises audio/video data of the first user.

4. The live streaming platform server of claim 1, wherein the first content captured of the first user comprises chat data inputted by the first user.

5. The live streaming platform server of claim 1, wherein the first content captured of the first user and the second, different content captured of the second, different user are each associated with a community game lobby.

6. The live streaming platform server of claim 5, wherein in association with the community game lobby, the first device and the second, different device each operate as a streaming device.

7. The live streaming platform server of claim 6, wherein the operation as the streaming device is sequential.

8. The live streaming platform server of claim 1, wherein the first content captured of the first user is associated with a community game participated in by the first user and the second, different user.

9. The live streaming platform server of claim 1, wherein the first device comprises another client device.

10. A system comprising:
a processor; and
a memory device that stores a plurality of instructions that, when executed by the processor, cause the processor to:
enable a first user of a first device selected to participate in a multiple participant event to interact with a second user of a second, different device selected to participate in the multiple participant event,
cause the first device to capture first audio/video data of the first user interacting with the second user,
enable the second user of the second, different device to interact with the first user of the first device,
cause the second, different device to capture second audio/video data of the second user interacting with the first user, and
responsive to a receipt of at least one of the first audio/video data and the second audio/video data, cause a client device to display a live stream comprising the at least one of the first audio/video data and the second audio/video data in association with the multiple participant event.

11. The system of claim 10, wherein at least one of the first audio/video data and the second audio/video data is associated with a lobby prior to an initiation of the multiple participant event.

12. A method of operating a live streaming platform server, the method comprising:
following an occurrence of a community game triggering event, an occurrence of a first community game participant selection event associated with a first user of a first device, and an occurrence of a second community game participant selection event associated with a second, different user of a second, different device and responsive to a receipt, from the first device, of data associated with first content captured of the first user, communicating, to a client device and at least partially based on the data associated with the first content, data associated with a first portion of a live stream, and
following the occurrence of the community game triggering event, the occurrence of the first community game participant selection event associated with the first user of the first device, and the occurrence of the second community game participant selection event associated with the second, different user of the second, different device and responsive to a receipt, from the second, different device, of data associated with second, different content captured of the second, different user, communicating, to the client device and at least partially based on the data associated with the second, different content, data associated with a second portion of the live stream.

13. The method of claim 12, wherein the first portion of the live stream and the second portion of the live stream occur at different points in time of the live stream.

14. The method of claim 12, wherein the first content captured of the first user comprises audio/video data of the first user.

15. The method of claim 12, wherein the first content captured of the first user comprises chat data inputted by the first user.

16. The method of claim 12, wherein the first content captured of the first user and the second, different content captured of the second, different user are each associated with a community game lobby.

17. The method of claim 16, wherein in association with the community game lobby, the first device and the second, different device each operate as a streaming device.

18. The method of claim 17, wherein the operation as the streaming device is sequential.

19. The method of claim 12, wherein the first content captured of the first user is associated with a community game participated in by the first user and the second, different user.

20. The method of claim 12, wherein the first device comprises another client device.
